(19) United States
(12) Patent Application Publication
(10) Pub. No.: US 2025/0265040 A1
(43) Pub. Date: Aug. 21, 2025

(54) OPTIMIZING INCOMPLETENESS OF POLYNOMIAL MULTIPLICATION IN A QUOTIENT RING

(71) Applicant: LG ELECTRONICS INC., Seoul (KR)

(72) Inventors: Syed Mahbub HAFIZ, Seoul (KR); Bahattin YILDIZ, Seoul (KR); Marcos Antonio SIMPLICIO, JR., Seoul (KR); Thales Bandiera PAIVA, Seoul (KR); Henrique Seiti OGAWA, Seoul (KR); Eduardo Lopes COMINETTI, Seoul (KR)

(73) Assignee: LG ELECTRONICS INC., Seoul (KR)

(21) Appl. No.: 18/930,317

(22) Filed: Oct. 29, 2024

Related U.S. Application Data
(60) Provisional application No. 63/555,099, filed on Feb. 19, 2024.
(60) Provisional application No. 63/654,005, filed on May 30, 2024.

(51) Int. Cl. G06F 7/523

(52) U.S. Cl. CPC G06F 7/523

(57) ABSTRACT

Optimizing an iterative polynomial multiplication related operation including obtaining first and second costs associated with modular addition and modular multiplication, respectively, based on a configuration of an electronic device; obtaining a number of polynomial coefficients for the operation corresponding to a particular setting; determining an optimal level of incompleteness of iterative polynomial multiplication layers and an optimal prime modulus by maximizing a defined gain function; wherein maximizing the defined gain function comprises determining the optimal level of incompleteness and the prime modulus resulting in a largest difference between a first computational cost of a complete execution of the iterative polynomial multiplication layers of the operation and each of a plurality of second computational costs respectively associated with varying prime moduli and levels of incompleteness of execution of the iterative polynomial multiplication layers of the operation.

### CROSS-REFERENCE TO RELATED APPLICATIONS

Pursuant to 35 U.S.C. § 119(e), this application claims the benefit of U.S. Provisional Patent Application No. 63/555,099, filed on Feb. 19, 2024 and 63/654,005, filed on May 30, 2024, the contents of which are all hereby incorporated by reference herein in their entirety.

### FIELD

The present disclosure generally relates to optimizing polynomial multiplication in a quotient ring implementing incompleteness of Number Theoretic Transform, associated ring prime modulus, target platform constraints, and required security level parameters.

### BACKGROUND

Lattice-based cryptography is today among the most prominent approaches for building post-quantum cryptography (PQC) schemes. It can be used, for example, in quantum-safe key encapsulation mechanisms (KEM), digital signature algorithms (DSA), and privacy-enhancing technologies (PETs) such as fully homomorphic encryption (FHE). PQC is gaining increasing relevance today because, due to Shor's algorithm, cryptographic algorithms based on classical computationally hard problems (e.g., integer factorization and discrete logarithms) will become vulnerable to adversaries having access to a large-scale, cryptographically relevant quantum computer (CRQC).

Hence, digital communications should adopt cryptographic algorithms to become quantum-resistant to face the threat posed by the continuous advances in quantum computation. Understanding this urgency, the National Institute of Standards and Technology (NIST) launched in 2016 an international standardization process to identify prominent KEM and DSA schemes. Most of them are built on lattice-based computationally hard problems, such as learning with errors (LWE) and short integer solution (SIS), conjectured to be secure against both classical and quantum computing-enabled adversaries.

At the same time, governments and humanitarian organizations are getting more concerned about preserving user data privacy. Even though user data is instrumental in many solutions, such as effectively training machine learning models, accessing such sensitive data while preserving their owners' privacy is becoming imperative (and, often, a legal requirement). Fully homomorphic encryption (FHE) is a promising technique for tackling this issue, as it enables arbitrary computation over encrypted data rather than requiring its decryption prior to processing.

Lattice cryptography is today among the main tools employed to build practical FHE algorithms. Beyond the foundational significance of lattices in promoting quantum-resistant security and enabling privacy-preserving data processing, their intrinsic computational properties are also relevant. In particular, lattices support parallel computation and scalability through varying security levels.

Nevertheless, deploying PQC and FHE solutions on resource-constrained edge devices, such as microcontrollers and embedded appliances commonly found in Internet-of-Things (IoT) systems, requires highly efficient implementations in computing, bandwidth, and memory. Achieving optimal values for each metric can be challenging and, depending on the context, one may have to find suitable trade-offs between them.

Doing so usually involves the optimization of polynomial multiplications in quotient rings, one of the main operations executed by lattice-based algorithms. For instance, on average, 30-50% of total computation in lattice cryptography-based PQC and FHE schemes is related to NTT-based polynomial multiplication.

For polynomials having n coefficients, the computational complexity of the traditional schoolbook polynomial multiplication algorithm is [symbol] (n²), whereas the cost of 2-way Toom-Cook algorithm (also named Karatsuba) is [symbol] (n^{1.58}). The most efficient polynomial multiplication algorithm known in the literature is the Number Theoretic Transform (NTT): this finite-field equivalent of the Fast Fourier Transform (FFT) has a computational complexity of [symbol] (n lg n).

Most of the existing algorithm-, software-, and hardware-level optimization methods to enhance the NTT-based polynomial multiplication performance are grounded on a regular, complete execution of NTT. In an iterative algorithm, like NTT, a layer consists of all operations appearing at the same level in the execution tree formed by the underlying iterative calls. In some cases, it has been shown that leveraging the properties of cyclotomic polynomials and the Chinese Remainder Theorem (CRT), performance enhancement can be achieved by stopping at earlier layers of the NTT.

One example implementing such optimization is Kyber, a quantum-resistant KEM approved by NIST. The current standard of Kyber uses one less layer for improved performance. However, this implementation of performing one less layer was empirical rather than based on a formal analysis, and the correlation between various potential alternatives and performance, ciphertext size, and other metrics remain largely unexplored.

More generally, there have been no studies that comprehensively explore and formally define the entire range and benefits of this flexibility of NTT, also referred to as “incompleteness”.

Thus, what is needed is a new approach that leverages incomplete NTT-based polynomial multiplications. This would enable the execution of Schoolbook or Karatsuba algorithms for the small-degree polynomials appearing at the last layers of the NTT, leading to faster execution time.

Besides improved performance, such an approach would enable the ability to relax other restrictions on relevant parameters, where a complete NTT or even the Kyber one layer incompleteness would not provide such flexibility, such as the degree of the quotient polynomial n and the modulus q. This flexibility on parameters, in turn, would provide improvements to other metrics like security and overall performance of each application.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 is a block diagram of an example computing system in accordance with some implementations.

FIG. 2 is a block diagram showing an example of a target computing device in accordance with some implementations.

FIGS. 3A-3C are graphs showing performance of Schoolbook, Karatsuba, Toom-Cook, and complete NTT multiplication algorithms.

FIG. 4 is a diagram of an implementation of incomplete NTT in accordance with some implementations.

FIGS. 5A-5D are pseudo-code representations of algorithms in accordance with some implementations.

FIG. 6 is a diagram showing optimization of polynomial multiplication related operations in accordance with some implementations.

FIGS. 7A-15 are graphs showing performance optimization of polynomial multiplication related operations in accordance with some implementations.

FIG. 16 is a flowchart showing a method for optimization of polynomial multiplication related operations in accordance with some implementations.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### SUMMARY

The present disclosure is directed to embodiments optimizing a configuration of incomplete NTT-based polynomial multiplications. Specifically, for a target computing platform, application, and security level, the disclosed embodiments include optimizing parameters including the number of layers to be skipped and the corresponding finite field prime modulus.

The full spectrum of incompleteness in NTT-based polynomial multiplications (i.e., applicable in both cyclic and nega-cyclic convolutions) is considered. For instance, embodiments of the present disclosure establish that an incomplete NTT enables a broader and more relaxed set of compatible moduli, and depending on the target scenario, and improved performance, enhanced security, and better values for critical parameters are achieved based on a determined modulus.

Moreover, embodiments of the present disclosure represent significant improvements over various existing approaches like regular NTT, Karatsuba, Toom-Cook, and Schoolbook, and the disclosed embodiments also enable different combinations of the above algorithms for the base polynomial multiplications appearing after the incomplete NTT calls, opening a “mixing-and-matching” door to implementations of various options depending on the context.

The embodiments of the present disclosure implement polynomial multiplication strategies which may be applied to optimize any application involving polynomial multiplication and, thus, lattice-based cryptography, including but not limited to fully homomorphic encryption, zero-knowledge proofs, and other use cases, delivering better security and performance tradeoffs.

For example, an embodiment of the present disclosure includes a method for optimizing an iterative polynomial multiplication related operation for execution by an electronic device, the method comprising obtaining a first cost associated with modular addition and a second cost associated with modular multiplication based on a configuration of the electronic device, obtaining a number of polynomial coefficients for the iterative polynomial multiplication related operation corresponding to a particular setting of the iterative polynomial multiplication related operation, determining an optimal level of incompleteness of iterative polynomial multiplication layers of the iterative polynomial multiplication related operation and a prime modulus for performing the iterative polynomial multiplication related operation by maximizing a defined gain function using the first cost, the second cost, and the number of polynomial coefficients, based on the particular setting, wherein maximizing the defined gain function comprises determining the optimal level of incompleteness and the prime modulus resulting in a largest difference between a first computational cost of a complete execution of the iterative polynomial multiplication layers of the iterative polynomial multiplication related operation and each of a plurality of second computational costs respectively associated with varying levels of incompleteness of execution of the iterative polynomial multiplication layers of the iterative polynomial multiplication related operation, and causing the electronic device to execute the optimized polynomial multiplication related operation based on the determined optimal level of incompleteness and the prime modulus.

Another embodiment of the present disclosure includes wherein the optimized iterative polynomial multiplication related operation is executed by performing a first number of layers of polynomial multiplication of the optimized iterative polynomial multiplication related operation using a first polynomial multiplication algorithm, and performing remaining tasks of polynomial multiplication of the optimized polynomial multiplication related operation using a second multiplication algorithm, wherein the first number is determined as the specific level of incompleteness.

Another embodiment of the present disclosure includes wherein the first polynomial multiplication algorithm utilizes Number Theoretic Transform (NTT)-based polynomial multiplication.

Another embodiment of the present disclosure includes wherein the second polynomial multiplication method is a Karatsuba or Schoolbook polynomial multiplication algorithm.

Another embodiment of the present disclosure includes wherein the prime modulus is fixed for determining the optimal level of incompleteness.

Another embodiment of the present disclosure includes wherein the iterative polynomial multiplication related operation is a cryptographic operation and the particular setting is a target security level of the cryptographic operation.

Another embodiment of the present disclosure further comprises determining a set of prime modulus candidates satisfying the target security level for each level of incompleteness of polynomial multiplication layers of the iterative polynomial multiplication related operation, wherein the prime modulus is included in one set of prime modulus candidates.

Another embodiment of the present disclosure includes wherein each prime modulus in a set of prime modulus candidates is equivalent to 1 mod [symbol] , where [symbol] represents a respective level of incompleteness of polynomial multiplication layers of the cryptographic operation corresponding to the set.

Another embodiment of the present disclosure includes wherein the cryptographic operation is executed based on the determined optimal level of incompleteness and the prime modulus to perform at least one of: generating a public key; generating a private key; generating a digital signature; verifying a digital signature; encrypting data; or decrypting data.

An embodiment of the present disclosure includes a non-transitory computer-readable medium storing instructions that, when executed by a processor of a first electronic device, causes the first electronic device to: obtain a first cost associated with modular addition and a second cost associated with modular multiplication based on a configuration of a second electronic device on which an optimized iterative polynomial multiplication related operation is to be performed; obtaining a number of polynomial coefficients for the iterative polynomial multiplication related operation corresponding to a particular setting of the iterative polynomial multiplication related operation; determining an optimal level of incompleteness of iterative polynomial multiplication layers of the iterative polynomial multiplication related operation and a prime modulus for performing the iterative polynomial multiplication related operation by maximizing a defined gain function using the first cost, the second cost, and the number of polynomial coefficients, based on the particular setting; wherein maximizing the defined gain function comprises determining the optimal level of incompleteness and the prime modulus resulting in a largest difference between a first computational cost of a complete execution of the iterative polynomial multiplication layers of the iterative polynomial multiplication related operation and each of a plurality of second computational costs respectively associated with varying levels of incompleteness of execution of the iterative polynomial multiplication layers of the iterative polynomial multiplication related operation; and providing to the second electronic device configuration of the optimized polynomial multiplication related operation for execution by the second electronic device based on the determined optimal level of incompleteness and the prime modulus.

Another embodiment of the present disclosure includes a system for optimizing an iterative polynomial multiplication related operation for execution by an electronic device, the system comprising: one or more processors; and a memory storing instructions that, when executed by the one or more processors causes the system to: obtain a first cost associated with modular addition and a second cost associated with modular multiplication based on a configuration of an electronic device on which an optimized iterative polynomial multiplication related operation is to be performed; obtain a number of polynomial coefficients for the iterative polynomial multiplication related operation corresponding to a particular setting of the iterative polynomial multiplication related operation; determine an optimal level of incompleteness of iterative polynomial multiplication layers for performing the iterative polynomial multiplication related operation and a prime modulus for performing the iterative polynomial multiplication related operation by maximizing a defined gain function using the first cost, the second cost, and the number of polynomial coefficients, based on the particular setting; wherein maximizing the defined gain function comprises determining the optimal level of incompleteness and the prime modulus resulting in a largest difference between a first computational cost of a complete execution of the iterative polynomial multiplication layers of the iterative polynomial multiplication related operation and each of a plurality of second computational costs respectively associated with varying levels of incompleteness of execution of the iterative polynomial multiplication layers of the iterative polynomial multiplication related operation; and provide to the electronic device configuration of the optimized polynomial multiplication related operation for execution by the electronic device based on the determined optimal level of incompleteness and the prime modulus.

### DETAILED DESCRIPTION

Hereinafter, the embodiments disclosed in the present specification will be described in detail with reference to the accompanying drawings, the same or similar elements regardless of a reference numeral are denoted by the same reference numeral, and a duplicate description thereof will be omitted. In the following description, the terms “module” and “unit” for referring to elements are assigned and used exchangeably in consideration of convenience of explanation, and thus, the terms per se do not necessarily have different meanings or functions. Wherever possible, the same reference numbers will be used throughout the drawings to refer to the same or like parts. In the following description, known functions or structures, which may confuse the substance of the present disclosure, are not explained. The accompanying drawings are used to help easily explain various technical features, and it should be understood that the embodiments presented herein are not limited by the accompanying drawings. As such, the present disclosure should be construed to extend to any alterations, equivalents, and substitutes in addition to those which are particularly set out in the accompanying drawings.

The terminology used herein is used for the purpose of describing particular example implementations only and is not intended to be limiting. As used herein, the singular forms “a,” “an,” and “the” may be intended to include the plural forms as well, unless the context clearly indicates otherwise. The terms “comprises,” “comprising,” “includes,” “including,” “containing,” “has,” “having” or other variations thereof are inclusive and therefore specify the presence of stated features, integers, steps, operations, elements, and/or components, but do not preclude the presence or addition of one or more other features, integers, steps, operations, elements, components, and/or groups thereof. Furthermore, these terms such as “first,” “second,” and other numerical terms, are used only to distinguish one element from another element. These terms are generally only used to distinguish one element from another.

Hereinafter, implementations of the present disclosure will be described in detail with reference to the accompanying drawings. Like reference numerals designate like elements throughout the specification, and overlapping descriptions of the elements will not be provided.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present.

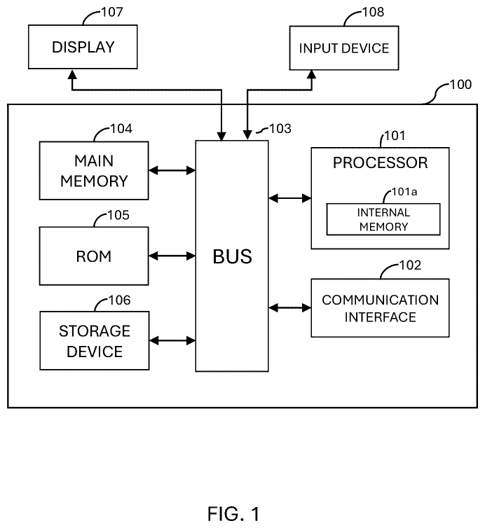

Referring now to FIG. 1, an illustration of an example computer 100 is provided which may be used to embody, implement, execute, or perform embodiments of the present disclosure. In selected embodiments, the computer 100 may include a bus 103 (or multiple buses) or other communication mechanism, a processor 101, processor internal memory 101a, main memory 104, read only memory (ROM) 1305, one or more additional storage devices 106, and/or a communication interface 102, or the like or sub-combinations thereof. The embodiments described herein may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a selective combination thereof. In all embodiments, the various components described herein may be implemented as a single component, or alternatively may be implemented in various separate components.

A bus 103 or other communication mechanism, including multiple such buses or mechanisms, may support communication of information within the computer 100. The processor 101 may be connected to the bus 103 and process information. In selected embodiments, the processor 101 may be a specialized or dedicated microprocessor configured to perform particular tasks in accordance with the features and aspects disclosed herein by executing machine-readable software code defining the particular tasks. In some embodiments, multiple processors 101 may be provided with each processing unit dedicated to a particular specialized task, such as graphics processing or artificial intelligence related processing.

Main memory 104 (e.g., random access memory—or RAM—or other dynamic storage device) may be connected to the bus 103 and store information and instructions to be executed by the processor 101. Processor 101 may also include internal memory 101a, such as CPU cache implemented by SRAM, for storing data used for executing instructions. Utilization of internal memory 101a may optimize data and memory management by reducing memory bandwidth usage with main memory 104. Although FIG. 1 depicts internal memory 101a as a component of processor 101, it will be understood that embodiments are included wherein internal memory 101a is a separate component apart from processor 101. Main memory 104 may also store temporary variables or other intermediate information during execution of such instructions.

ROM 105 or some other static storage device may be connected to a bus 103 and store static information and instructions for the processor 101. An additional storage device 106 (e.g., a magnetic disk, optical disk, memory card, or the like) may be connected to the bus 103. The main memory 104, ROM 105, and the additional storage device 106 may include a non-transitory computer-readable medium holding information, instructions, or some combination thereof, for example instructions that when executed by the processor 101, cause the computer 100 to perform one or more operations of a method as described herein. A communication interface 102 may also be connected to the bus 103. A communication interface 102 may provide or support two-way data communication between a computer 100 and one or more external devices (e.g., other devices contained within the computing environment).

In selected embodiments, the computer 100 may be connected (e.g., via a bus) to a display 107. The display 107 may use any suitable mechanism to communicate information to a user of a computer 100. For example, the display 107 may include or utilize a liquid crystal display (LCD), light emitting diode (LED) display, projector, or other display device to present information to a user of the computer 100 in a visual display. One or more input devices 108 (e.g., an alphanumeric keyboard, mouse, microphone, stylus pen) may be connected to the bus 103 to communicate information and commands to the computer 100. In selected embodiments, one input device 108 may provide or support control over the positioning of a cursor to allow for selection and execution of various objects, files, programs, and the like provided by the computer 1300 and displayed by the display 107.

The computer 100 may be used to transmit, receive, decode, display, or the like one or more image or video files. In selected embodiments, such transmitting, receiving, decoding, and displaying may be in response to the processor 101 executing one or more sequences of one or more instructions contained in main memory 104. Such instructions may be read into main memory 104 from another non-transitory computer-readable medium (e.g., a storage device).

Execution of sequences of instructions contained in main memory 104 may cause the processor 101 to perform one or more of the procedures or steps described herein. In selected embodiments, one or more processors in a multi-processing arrangement may also be employed to execute sequences of instructions contained in main memory 104. Alternatively, or in addition thereto, firmware may be used in place of, or in connection with, software instructions to implement procedures or steps in accordance with the features and aspects disclosed herein. Thus, embodiments in accordance with the features and aspects disclosed herein may not be limited to any specific combination of hardware circuitry and software.

Non-transitory computer readable medium may refer to any medium that participates in holding instructions for execution by the processor 101, or that stores data for processing by a computer, and comprise all computer-readable media, with the sole exception being a transitory, propagating signal. Such a non-transitory computer readable medium may include, but is not limited to, non-volatile media, volatile media, and temporary storage media (e.g., cache memory). Non-volatile media may include optical or magnetic disks, such as an additional storage device. Volatile media may include dynamic memory, such as main memory. Common forms of non-transitory computer-readable media may include, for example, a hard disk, a floppy disk, magnetic tape, or any other magnetic medium, a CD-ROM, DVD, Blu-ray or other optical medium, RAM, PROM, EPROM, FLASH-EPROM, any other memory card, chip, or cartridge, or any other memory medium from which a computer can read.

In selected embodiments, a communication interface 102 may provide or support external, two-way data communication to or via a network link. For example, a communication interface 102 may be a wireless network interface controller or a cellular radio providing a data communication network connection. Alternatively, a communication interface 102 may comprise a local area network (LAN) card providing a data communication connection to a compatible LAN. In any such embodiment, a communication interface 102 may send and receive electrical, electromagnetic, or optical signals conveying information.

A network link may provide data communication through one or more networks to other data devices (e.g., other computers such as 100, or terminals of various other types). For example, a network link may provide a connection through a local network of a host computer or to data equipment operated by an Internet Service Provider (ISP). An ISP may, in turn, provide data communication services through the Internet. Accordingly, a computer 100 may send and receive commands, data, or combinations thereof, including program code, through one or more networks, a network link, and communication interface 102. Thus, the computer 100 may interface or otherwise communicate with a remote server, or some combination thereof.

The various devices, modules, terminals, and the like discussed herein may be implemented on a computer by execution of software comprising machine instructions read from computer-readable medium, as discussed above. In certain embodiments, several hardware aspects may be implemented using a single computer, in other embodiments multiple computers, input/output systems and hardware may be used to implement the system.

For a software implementation, certain embodiments described herein may be implemented with separate software modules, such as procedures and functions, each of which perform one or more of the functions and operations described herein. The software codes can be implemented with a software application written in any suitable programming language and may be stored in memory and executed by a controller or processor.

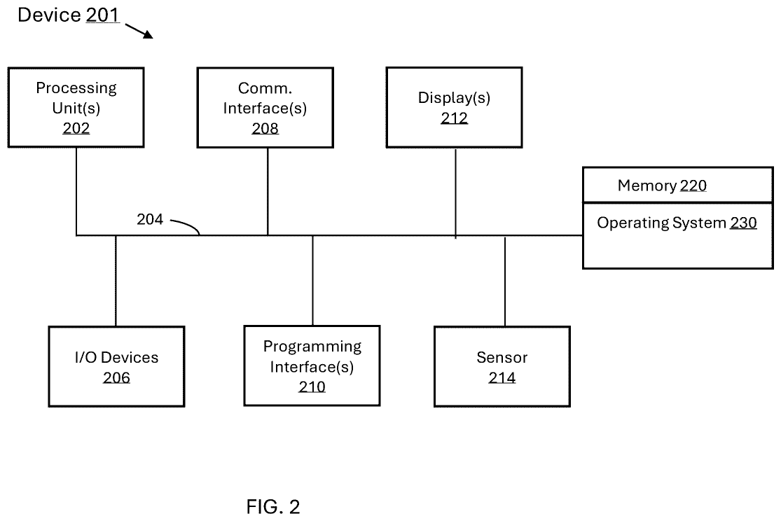

FIG. 2 is a block diagram of an example of a device 201, also referred to as an edge device, deployed device, target computing platform, or the like, in accordance with some implementations. While certain specific features are illustrated, those of ordinary skill in the art will appreciate from the present disclosure that various other features have not been illustrated for the sake of brevity, and so as not to obscure more pertinent aspects of the implementations disclosed herein.

To that end, as a non-limiting example, in some implementations the edge device (in some cases implemented as the computer 100 shown in FIG. 1) or the device 201 includes one or more processing units 202 (e.g., microprocessors, ASICs, FPGAs, GPUs, CPUs, processing cores, and/or the like), one or more I/O devices and sensors 206, one or more communications interfaces 208 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like, type interfaces), one or more programming (e.g., I/O) interfaces 210, one or more displays 212, one or more exterior image sensors 214, a memory 220, and one or more communication buses 204 for interconnecting these and various other components.

In some implementations, the one or more communication buses 204 include circuitry that interconnects and controls communications between system components.

In some implementations, the one or more displays 212 are capable of presenting content. In some implementations, the one or more displays 212 are also configured to present flat video content to the user (e.g., a 2-dimensional or “flat” audio video interleave (AVI), flash video (FLV), Windows Media Video (WMV), or the like file associated with a TV episode or a movie, or live video pass-through of the operating environments.

In some implementations, the one or more displays 212 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro mechanical systems (MEMS), and/or the like display types. In some implementations, the one or more displays 212 correspond to diffractive, reflective, polarized, holographic, etc. waveguide displays. For example, the device 201 includes a single display. In another example, the device 201 includes a display for each eye of the user.

In some implementations, the one or more exterior image sensors 214 are configured to obtain image data frames. For example, the one or more optional exterior- and/or interior-facing image sensors 214 correspond to one or more RGB cameras (e.g., with a complementary metal-oxide-semiconductor (CMOS) image sensor, or a charge-coupled device (CCD) image sensor), infrared (IR) image sensors, event-based cameras, and/or the like.

The memory 220 includes high-speed random-access memory, such as DRAM, SRAM, DDR RAM, or other random-access solid-state memory devices. In some implementations, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some implementations, the memory 220 or the non-transitory computer readable storage medium of the memory 220 stores the following programs, modules and data structures, or a subset thereof including an optional operating system 230. The optional operating system 230 includes procedures for handling various basic system services and for performing hardware dependent tasks.

FIG. 2 is intended more as a functional description of the various features that could be present in a particular implementation as opposed to a structural schematic of the implementations described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

Turning to various embodiments of the present disclosure, existing baseline algorithms for polynomial multiplication will be discussed.

For small-degree polynomials, regular NTT does not present the best choice for polynomial multiplication in a quotient ring. Evaluation of the number of CPU cycles required to complete a polynomial multiplication of two arbitrary input polynomials in a quotient ring provide basis for this conclusion. For purposes of this disclosure, and by way of example only, a testbed using C language for the following baseline algorithms will be used—Schoolbook, Karatsuba, 3-way Toom-Cook, 4-way Toom-Cook, and regular (i.e., complete) NTT. However, it will be understood that the present disclosure may be implemented with various other compatible configurations.

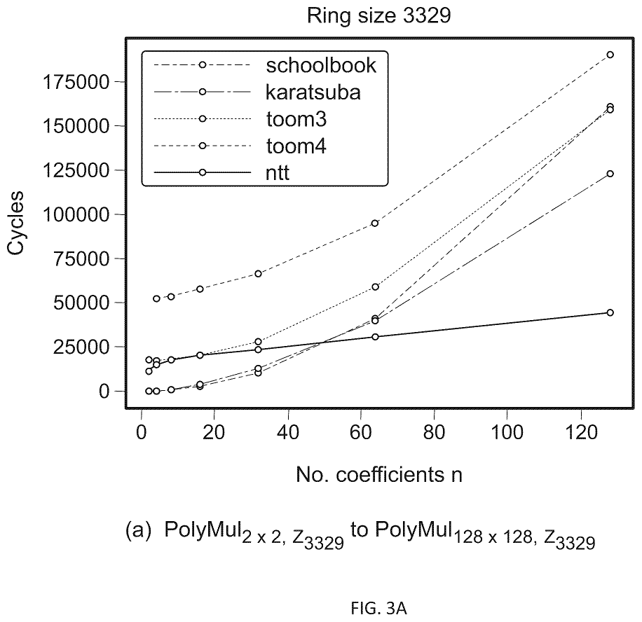

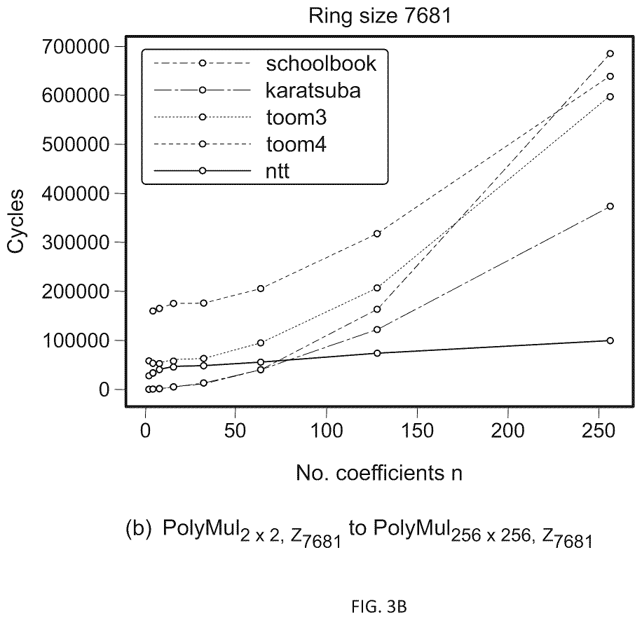

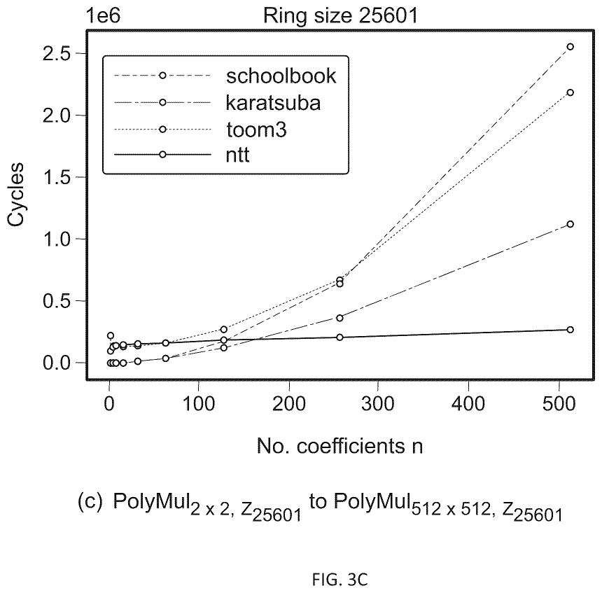

For the purposes of this discussion, each baseline algorithm was executed for 100 trials and their average execution time is shown in FIGS. 3A-3C. Data is shown for polynomials having different number of coefficients n (namely, 25≤n≤512) and for multiple finite field moduli q (namely, q={3329, 7681, 25601}, each of which defines a different ring size).

As shown in FIG. 3, for a given q, Schoolbook and Karatsuba perform better (less cycles) than complete NTT for smaller values of n.

In particular, for a fixed q=3329 (FIG. 3A), when two input polynomials having n≤50 are multiplied, Schoolbook/Karatsuba presents a better choice.

Likewise, for q=7681 (FIG. 3B) and q=25601 (FIG. 3C), Schoolbook/Karatsuba exhibits better efficiency when the number of coefficient n are smaller than 80 and 120, respectively.

The overall trend indicates that when the modulus is increased, also increased is the optimal value of n that switches back to the Schoolbook/Karatsuba algorithm as being a better choice than regular NTT.

Pertinent properties of cyclotomic polynomials and how they impact techniques like the Chinese remainder theorem (CRT) and the number-theoretic transform (NTT) will now be discussed.

### Cyclotomics

For m≥1, let ωₘ∈ [symbol] be a primitive m-th root of unity. We can take for example

$${ω}_{m} = {e}^{\frac{2 π i}{m}} .$$

It is clear that ωₘ is a generator for the multiplicative group of all mth roots of unity.

From Number Theory, we know that if ωₘ is a primitive root of unity, then ωₘ^{j} is a primitive root of unity if and only if GCD(j, m)=1 or equivalently, j∈ [symbol] *ₘ, i.e., the multiplicative group of reduced residue classes modulo m. Thus, the set of all primitive mth roots of the unit is given by {ωₘ^{j}|∈ [symbol] *ₘ}.

We now take the polynomial Φₘ(x)= [symbol] (x−ωₘ), which is a monic polynomial of degree ϕ(m), where ϕ is the Euler Totient function. This is called the mth cyclotomic polynomial. Some interesting facts about the cyclotomic polynomials are that Φₘ(x)∈ [symbol] [x], Φₘ(x)|x^{m}−1 in [symbol] [x], Φₘ(x)łx^{k}−1 in [symbol] [x] for any k<n, and Φₘ(x) is irreducible over [symbol] .

As a special case, if m=2^{k+1} for some integer k≥0, then ϕ(m)=m/2=2^{k} and so deg(Φₘ(x))=2^{k}. Since Φₘ(x)|x^{m}−1=(x²^{^{k}}−1)(x²^{^{k}}+1) and deg(Φₘ(x))=k and Φₘ(x) is irreducible over [symbol] , we must have Φₘ(x)=x²^{^{k}}+1 in this case.

The following theorem on cyclotomics and the subsequent corollary provides the basis for why they are useful in NTT:

Theorem 1. Let p be a prime number such that płm. Then Φₘ(x)=f₁(x)f₂(x) . . . [symbol] (x) in [symbol] ₚ[x], where fᵢ(x) are irreducible and pairwise relatively prime polynomials in [symbol] ₚ[x]. Moreover, each fᵢ(x) is of degree d, where

$$d = \frac{ϕ ( m )}{ℓ}$$

and d is the order of p mod m. That is d is the smallest positive integer such that p^{d}≡1 mod m.

An immediate corollary is the following:

Corollary 1. If p≡1 mod m, then Φₘ(x) splits into distinct linear factors modulo p. In this case we will have [symbol] \Phi_m(x)=\prod_{i\in \Z_m\hat{ }*}(x−a\hat{ }i), [symbol] where a is a primitive mth root of unity modulo p.

Example 1. Consider p(x)=x¹⁶+1, which is the 32nd cyclotomic polynomial (m=32). If we take q=3, then since 3⁸≡1 mod 32, we expect x¹⁶+1 to split into two factors of degree 8 each. Indeed we have

$${x}^{16} + 1 = ( {x}^{8} + {x}^{4} + 2 ) ( {x}^{8} + 2 {x}^{4} + 2 )$$

in [symbol] ₃[x].

To find a prime q so that x¹⁶+1 splits completely modulo in [symbol] ₚ[x], we need to find a prime p such that p≡1 mod 32. Such a p is 97. Indeed we have

$${x}^{16} + 1 = ( x + 19 ) ( x + 20 ) ( x + 28 ) ( x + 30 ) ( x + 34 )$$

$$( x + 42 ) ( x + 45 ) ( x + 46 ) ( x + 51 ) ( x + 52 )$$

$$( x + 55 ) ( x + 63 ) ( x + 67 )$$

$$( x + 69 ) ( x + 77 ) ( x + 78 )$$

in [symbol] ₉₇[x].

The different ways that cyclotomics can split are utilized to determine primes that will lead to a spectrum of cases of incomplete NTT.

### Chinese Remainder Theorem

The following theorem is the main description of the Chinese remainder theorem (CRT) for polynomials over a finite field:

Theorem 2. Assume that F is a field and let f(x)∈F[x] be a polynomial such that f(x)=f₁(x)f₂(x) . . . fₖ(x) in F[x], where f₁, f₂, . . . , fₖ are pairwise coprime polynomials. Then F[x]/(f)≃F[x]/(f₁)×F[x]/(f₂) . . . ×F[x]/(fₖ).

### NTT Incompleteness: Introduction

The NTT algorithm has an iterative nature: the multiplication of degree—(n−1) polynomials is done by splitting the inputs into two halves at each iteration, yielding a binary execution tree with k=lg n layers. It is possible, however, to stop the NTT execution at an earlier layer, leading to what is called an incomplete NTT method.

For the purposes of this discussion, let the number of coefficients of the polynomial be n=2^{k}. We define the incomplete NTT and incompleteness properties as follows:

Definition 1 (Incomplete and complete NTT). An ( [symbol] , k)-layer NTT is an algorithm that stops at [symbol] out of k layers. We have, k=logn and [symbol] ∈[1, k]. For the purposes of this discussion, we call an ( [symbol] , k)-layer NTT a complete NTT when [symbol] =k, and an incomplete NTT when [symbol] ∈[1, k−1].

Definition 2 (Incompleteness property). An ( [symbol] , k)-layer NTT has (k− [symbol] )-incompleteness.

Corollary 2 (Completeness property). An ( [symbol] , k)-layer NTT has [symbol] -completeness.

The motivation—discussed above—for employing an incomplete NTT is that at lower layers (i.e., for small-degree inputs), it may be more efficient to use another polynomial multiplication method than the one used for the regular NTT. We can, thus, take advantage of this flexibility to calculate the optimal amount of incompleteness for a target platform, considering requirements like execution time, memory usage, and security level.

Such optimizations may be relevant in practice because the computational and memory costs required to perform the underlying ring additions and multiplications using modulo arithmetic usually vary across platforms and applications. Once the incompleteness is defined, embodiments of the present disclosure involve selecting a best algorithm—for example, out of Schoolbook and Karatsuba—to multiply the (smaller-degree) inputs at the corresponding NTT layers.

After obtaining the products of constituent-wise polynomials, the inverse NTT operation is started from the earlier incomplete layer.

Finally, the method produces the coefficients of the product polynomial.

To fully describe the arbitrarily flexible incomplete NTT algorithm combining those steps, the following are a few operations employed when processing data in a forward and inverse NTT.

Definition 3 (Bit reversal). Let n be a non-negative integer such that 0≤n<2^{k} for some k. Then BitRevₖ(n) denotes the integer whose bit representation is the same as n when written in reverse.

Formally, if n=2^{k-1}nₖ₋₁+. . . +2n₁+n₀, then BitRevₖ(n)=2^{k-1}n₀+. . . +2nₖ₋₂+nₖ₋₁.

Observation 1. After an incomplete ( [symbol] , k)-layer NTT, the [symbol] elements or polynomials are in the

$${ℤ}_{q} [ x ] / ( {x}^{{2}^{k - ℓ}} - {ζ}_{{2}^{ℓ + 1}}^{ρ} )$$

polynomial quotient ring with ρ=2· [symbol] (i)+1, where i∈[0, [symbol] −1] and [symbol] ₊₁ is the primitive [symbol] ⁺¹-th root of unity.

Corollary 3. In this case, each of the constituent polynomials is degree—( [symbol] −1) and, thus, have [symbol] coefficients.

Theorem 3. An incomplete ( [symbol] , k)-layer NTT factors the quotient polynomial xⁿ+1 into

$${\prod }_{i = 0}^{i = {2}^{ℓ} - 1} ( {x}^{{2}^{k - ℓ}} - {ζ}_{{2}^{ℓ + 1}}^{2 \cdot {BitRev}_{ℓ} ( i ) + 1} ) .$$

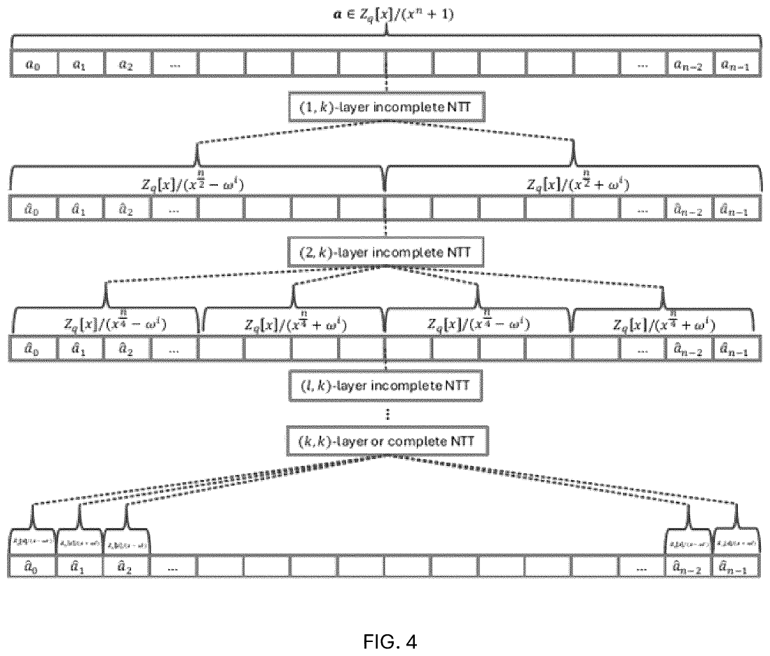

Theorem 3 is illustrated in FIG. 4. The underlying polynomial quotient ring is [symbol] _{q}[x]/(xⁿ+1) for negacyclic convolution-based polynomial multiplication. After a complete (k, k)-layer NTT, the elements or polynomials are in

$${ℤ}_{q} [ x ] / ( {x}^{{2}^{0}} - {ζ}_{\frac{2 n}{{2}^{0}}}^{ρ} ) = {ℤ}_{q} [ x ] / ( {x}^{{2}^{0}} - {ζ}_{\frac{2 : {2}^{k}}{{2}^{0}}}^{ρ} ) = {ℤ}_{q} [ x ] / ( {x}^{{2}^{0}} - {ζ}_{\frac{{2}^{k + 1}}{{2}^{0}}}^{ρ} ) = {ℤ}_{q} [ x ] / ( {x}^{{2}^{0}} - {ζ}_{{2}^{k + 1 - 0}}^{ρ} ) — the {2}^{k}$$

constituent polynomials are degree-(2⁰−1), or degree-0, or constant.

After an incomplete (k−1, k)-layer NTT, the elements or polynomials are in

$${ℤ}_{q} [ x ] / ( {x}^{{2}^{1}} - {ζ}_{\frac{2 n}{2}}^{ρ} ) = {ℤ}_{q} [ x ] / ( {x}^{{2}^{1}} - {ζ}_{{2}^{k + 1 - 1}}^{ρ} ) = {ℤ}_{q} [ x ] / ( {x}^{{2}^{1}} - {ζ}_{{2}^{k}}^{ρ} )$$

—in this case, the 2^{k-}1 constituent polynomials are degree-(2¹−1) or degree-1.

Likewise, after an incomplete ( [symbol] , k)-layer NTT, the 2 [symbol] elements or polynomials are in

$${ℤ}_{q} [ x ] / ( {x}^{{2}^{k - ℓ}} - {ζ}_{\frac{2 n}{{2}^{k - ℓ}}}^{ρ} ) = {ℤ}_{q} [ x ] / ( {x}^{{2}^{k - ℓ}} - {ζ}_{{2}^{k + 1 - k + ℓ}}^{ρ} ) = {ℤ}_{q} [ x ] / ( {x}^{{2}^{k - ℓ}} - {ζ}_{{2}^{ℓ + 1}}^{ρ} )$$

—in this case, the constituent polynomials are degree-( [symbol] −1).

Observation 2. For the (k− [symbol] )-incompleteness, we only require a primitive [symbol] -th root of unity, i.e., [symbol] .

Corollary 4. For the (k− [symbol] )-incompleteness, we require a prime modulus, q≡1 mod [symbol] .

For the (k− [symbol] )-incompleteness, we do not need a primitive 2n-th root of unity, but rather a primitive

$$\frac{2 n}{{2}^{k - ℓ}} = {2}^{ℓ + 1} - th$$

root or unity. This can be achieved by using a smaller q, as shown in Theorem 4.

Theorem 4. An incomplete ( [symbol] , k)-layer NTT can work with a smaller q than a corresponding complete or (k, k)-layer NTT.

Proof. A complete or (k, k)-layer NTT needs a modulus q≡1 mod 2^{k+1} and, from the Definition 1, we have [symbol] <k.

The following discusses an example implementing an embodiment of the present disclosure.

Example 2. Two polynomials are being multiplied with n=256=2⁸ coefficients so that k=8. If we employ a (5,8)-layer incomplete NTT-based multiplication, that means the NTT algorithm stops at layer [symbol] =5 out of k=8 layers.

We need a primitive 2⁵⁺¹=64-th root of unity instead of a 512-th one. One immediate implication is that to obtain the 512-th primitive root of unity, we need a prime modulus of at least 7681—conversely, for the 64-th primitive root of unity, a much smaller modulus is available, e.g., as small as 257.

After the 5-th layer, the (2⁵) elements or polynomials are in [symbol] _{q}[x]/(x²−ζ₂_{⁶}^{ρ})= [symbol] _{q}[x]/(x⁸−ζ₆₄^{ρ})—this case, the constituent polynomials are degree-(2³−1)=degree-7, and have 8 coefficients.

Furthermore, the (5,8)-layer incomplete NTT splits (x²⁵⁶+1) into

$${\prod }_{i = 0}^{i = 31} ( {x}^{8} - {ζ}_{64}^{2 \cdot {BitRev}_{5} ( i ) + 1} ) = ( {x}^{8} - {ζ}_{64}^{1} ) ( {x}^{8} - {ζ}_{64}^{33} ) … ( {x}^{8} - {ζ}_{64}^{31} ) ( {x}^{8} - {ζ}_{64}^{63} ) .$$

Corollary 5. For a given k-completeness, there is a minimum modulus qₘᵢₙ that satisfies q≡1 mod [symbol] , irrespective of the value of the original number of coefficients, n.

Example 3. For 1-completeness, qₘᵢₙ=5. Likewise for 2-completeness, qₘᵢₙ=17; for 3-completeness, qₘᵢₙ=17; for 4-completeness, qₘᵢₙ=97; for 5-completeness, qₘᵢₙ=193; for 6-completeness, qₘᵢₙ=257; for 7-completeness, qₘᵢₙ=257; for 8-completeness, qₘᵢₙ=7681; and so on.

As the completeness increases, the minimum prime modulus also gets larger.

### Incomplete (, k)-Layer NTT

In the following, construction of an adaptable and efficient ( [symbol] , k)-layer incomplete NTT for multiplying polynomials using negacyclic convolution (also transferable to cyclic convolution) in a quotient ring while considering specific platform and application constraints will be discussed according to embodiments of the present disclosure, which is particularly useful for (but not limited to) use in lattice-based cryptography.

As discussed, even if NTT is a better choice for large n, it becomes sub-optimal after some [symbol] layers. This happens because, at that point, the number of coefficients (or, essentially, the degree) reduces from 2^{k} to [symbol] —see Observation 1 and Corollary 3.

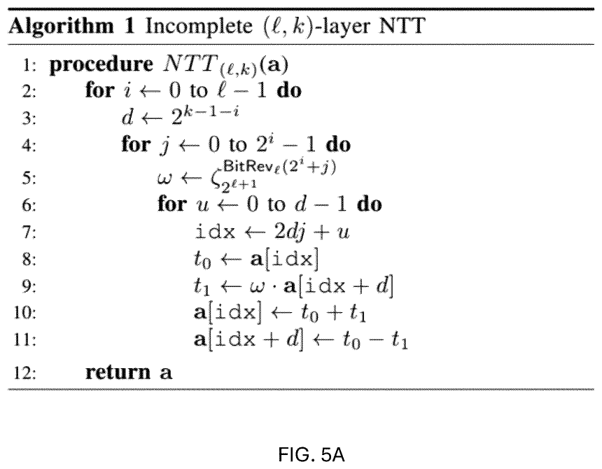

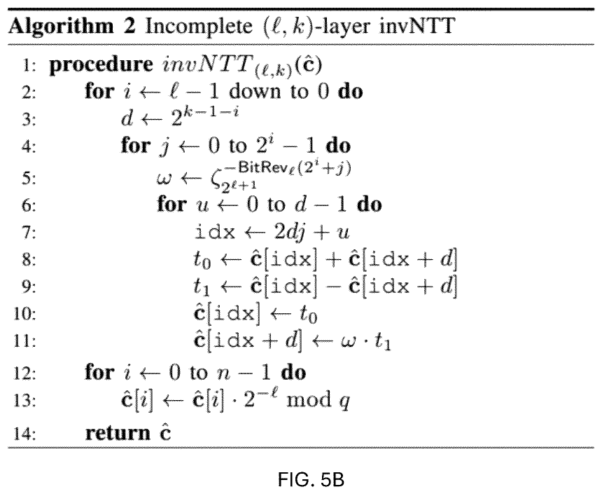

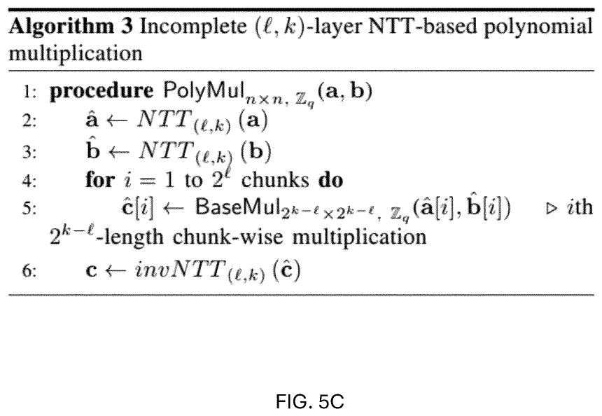

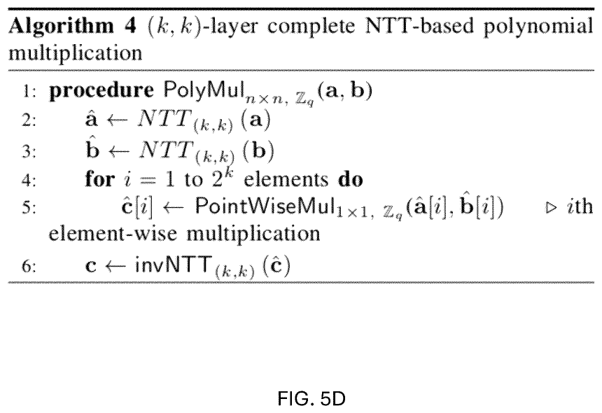

Therefore, it becomes more reasonable to employ Schoolbook or Karatsuba multiplication instead of completing the remaining layers following a regular NTT. Thus, according to embodiments of the present disclosure, negacyclic polynomial multiplication is illustrated in Algorithm 3, as shown in FIG. 5C (which builds upon arbitrary incomplete forward NTT Algorithm 1, shown in FIG. 5A, and inverse NTT Algorithm 2, shown in FIG. 5B). In FIG. 5C, [symbol] small-degree polynomials are multiplied using traditional Schoolbook or Karatsuba after Steps 2 and 3—see the [symbol] operation in Step 5 of Algorithm 3.

The new family of arbitrary incomplete NTT-driven algorithms according to embodiments of the present disclosure utilizes the following definitions.

Definition 4. [symbol] (a, b) is a negacyclic convolution-based algorithm to multiply two degree-(n−1) polynomials a, b∈ [symbol] _{q}[x]/(xⁿ+1). The product, c:= [symbol] (a, b) is also in [symbol] _{q}[x]/(xⁿ+1).

Definition 5. [symbol] (a, b) is a [symbol] (a, b) and occurs after an incomplete ( [symbol] , k)-layer NTT.

To evaluate the performance improvement achieved by incomplete NTT compared to complete NTT, we have the negacyclic polynomial multiplication using complete NTT in Algorithm 4, shown in FIG. 5D, which includes the following definition.

Definition 6. [symbol] (a, b) is a [symbol] (a, b), i.e., constant multiplication and occurs after a complete (k, k)-layer NTT, where a, b∈ [symbol] _{q}.

### Incompleteness for Relaxation on Moduli

Complete NTT imposes restrictions on moduli choice for a given n. The present disclosure establishes that incompleteness in NTT can ease such constraints and offer more choices for moduli selection for a given n. For example, for a required range of values, a complete NTT may not have any supported modulus, whereas the embodiments of the present disclosure include a family of incomplete NTTs that can permit a much broader set of moduli options.

Next, incompleteness in NTT may enable a more relaxed and larger set of moduli, as discussed further below.

Lemma 1. For [symbol] ≥1, there is a prime q such that q≡1 mod [symbol] , but q≢1 mod [symbol] .

Proof. Dirichlet's theorem states that if a, b∈ [symbol] are relatively prime (co-prime) to each other, there are infinitely many primes of the form q=a+mb with m∈ [symbol] . Thus, it can be assumed that a=1+ [symbol] and b= [symbol] .

Since a=1+ [symbol] is an odd number and b= [symbol] is a power of 2, they are co-prime to each other. Therefore, Dirichlet's theorem may be applied to find infinitely many primes of the form (1+ [symbol] )+m· [symbol] . However, if we take any one of these primes q=1+ [symbol] +m· [symbol] , we see that q≡1 mod [symbol] and q≡1+ [symbol] mod [symbol] ≢1 mod [symbol] . Consequently, a prime q (or, in fact, infinitely many) may be found such that q≡1 mod [symbol] , but q≢1 mod [symbol] .

A more general case may be established when [symbol] ₁< [symbol] ₂.

Lemma 2. For [symbol] ₁< [symbol] ₂, there is a prime q such that q≡1 mod [symbol] , but q≢1 mod [symbol] .

Proof. Assume [symbol] ₂= [symbol] ₁+m where m≥1 is a positive integer. According to Lemma 1, there is a prime q such that q≡1 mod [symbol] ^{+m-1}, but q≢1 mod [symbol] ^{+m}≢1 mod [symbol] . Since, m≥1, we have q≡1 mod [symbol] . Thus, a prime q may be found such that q≡1 mod [symbol] , but q≢1 mod [symbol] .

Theorem 5. Let [symbol] , [symbol] be two sets of moduli that support ( [symbol] ₁, k)-layer and ( [symbol] ₂, k)-layer incomplete NTT, respectively. If [symbol] ₁< [symbol] ₂ then [symbol] [symbol] [symbol] .

Proof. First we prove that [symbol] ⊂ [symbol] , then we show that [symbol] ≠ [symbol] . From Corollary 4, we know that [symbol] ={q₁:q₁≡1 mod [symbol] ⁺¹} and [symbol] ={q₂:q₂≡1 mod [symbol] ⁺¹}.

Take an element q₂ from set [symbol] . Then, for some integer m∈

$$ℕ$$

:

$${q}_{2} = 1 + m {2}^{{ℓ}_{2} + 1} = 1 + m {2}^{{ℓ}_{2} - {ℓ}_{1}} {2}^{{ℓ}_{1} + 1}$$

However, since [symbol] ₂− [symbol] ₁>0, then q₂≡1 mod [symbol] ⁺¹, which means that q₂ is also an element of [symbol] . Thus, it is established that [symbol] ⊂ [symbol] .

Now, from Lemma 2, there exists a prime q such that q∈ [symbol] but q∉ [symbol] when [symbol] ₁< [symbol] ₂. Therefore, it is established that [symbol] ≠ [symbol] and thus, that [symbol] [symbol] [symbol] .

### Achieving Optimal Incompleteness

From the above discussion, the disclosure includes a flexible incomplete NTT algorithm along with its unique advantage of permitting a broader set of moduli. Embodiments of the present disclosure further include optimizing the application of the polynomial multiplication related operation by selecting a best magnitude of incompleteness for a particular setup and configuration of a device to be configured to perform said operation.

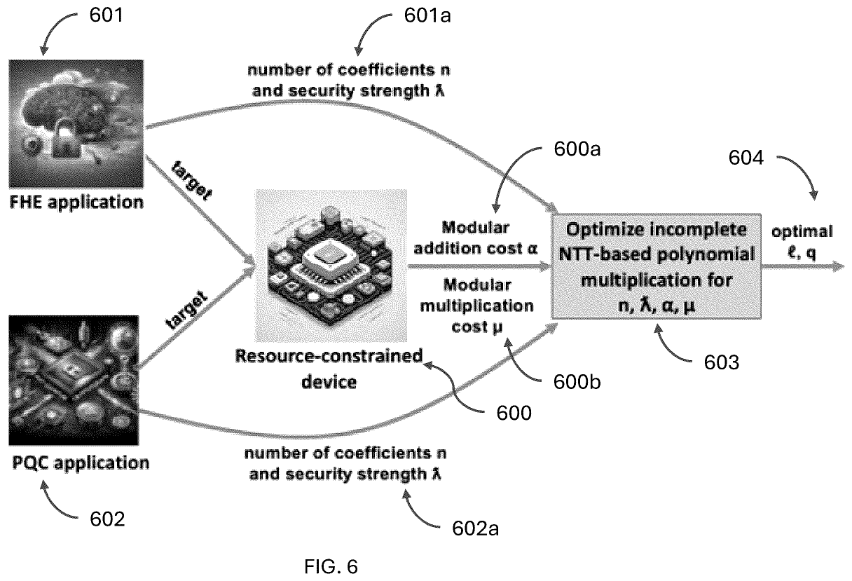

FIG. 6 illustrates an overview of an embodiment of the present disclosure for achieving optimal incompleteness, which will be discussed further as follows.

Definition 7. For a given target computing platform 600, let resources consumed for executing operation A be denoted by [symbol] (A) (read as “work in A”). Such resources can be measured by common metrics, such as the number of CPU cycles, elapsed wall-clock time, etc.

The following definitions are provided for capturing the computational costs of polynomial multiplication using complete and incomplete NTT implementations, as well as the differences between them:

Observation 3, is defined as follows, which provides “Work needed in complete NTT-based PolyMul”:

$$W ( Algorithm 4 ) = 𝒲 ( {NTT}_{( k , k )} ( a ) ) + 𝒲 ( {NTT}_{( k , k )} ( b ) ) + {2}^{k} \cdot W ( {PointWiseMul}_{1 \times 1 , {ℤ}_{q}} ) + W ( i n v N T {T}_{( k , k )} ( \hat{c} ) )$$

Observation 4, is defined as follows, which provides “Work needed in incomplete NTT-based PolyMul”:

$$W ( Algorithm 3 ) = 𝒲 ( {NTT}_{( ℓ , k )} ( a ) ) + 𝒲 ( {NTT}_{( ℓ , k )} ( b ) ) + {2}^{ℓ} \cdot W ( {BaseMul}_{{2}^{k - ℓ} \times {2}^{k - ℓ} , {ℤ}_{q}} ) + W ( {invNTT}_{( ℓ , k )} ( \hat{c} ) )$$

Definition 8 (Savings in incomplete NTT). For a given n, let [symbol] ( [symbol] ) (read as “savings in [symbol] ”) be the difference between [symbol] ( [symbol] ) and [symbol] (NTT_{(k,k)}), i.e.,

[symbol]

( [symbol] )= [symbol] (NTT_{(k,k)})− [symbol] ( [symbol] ).

Definition 9 (Overhead in incomplete NTT-based PolyMul). For a given n, let [symbol] (BaseMul) (read as “overhead in BaseMul”) be the difference between [symbol] ( [symbol] ) and [symbol] ( [symbol] ), i.e.,

$$𝒞 ( BaseMul ) = {2}^{ℓ} \cdot 𝒲 ( {BaseMul}_{{2}^{k - ℓ} \times {2}^{k - ℓ} , {ℤ}_{q}} ) - {2}^{k} \cdot 𝒲 ( {PointWiseMul}_{1 \times 1 , {ℤ}_{q}} )$$

The proposed Algorithm 3 can save a noticeable amount of work during its two calls of forward NTT and one call of reverse NTT, as it avoids some layers of regular computation. On the other hand, it incurs some overhead to multiply smaller-degree polynomials by BaseMul, compared to point-wise constant multiplication. There are performance gains to be obtained when the savings outweigh the incurred overhead, i.e., the incomplete NTT is better if the following condition is met:

Definition 10 (Incompleteness is better). For a given n, (k− [symbol] )-incompleteness is better if W(Algorithm 4)>W(Algorithm 3). Alternatively, if [symbol] (2· [symbol] + [symbol] )> [symbol] (BaseMul).

Also, according to Theorem 5, and Corollary 4 and Theorem 4, one significant benefit of incomplete NTT is its ability to operate with smaller moduli than those usually required for a complete NTT. Therefore, in principle, there are two degrees of liberty for optimization—the values of [symbol] and q, to choose according to any target computing environment.

Nevertheless, in many cryptographic applications, there is a relation between the chosen modulus and the associated security strength of a given cryptographic protocol, which may limit the choice of q. It is important, thus, to consider two scenarios when looking for optimal performance gains: when q can be chosen and when it is fixed by the application itself. Those scenarios are formalized as follows.

### Optimal Incompleteness When q can be Chosen

Definition 11 (SecurityAchieved(q)). For a given lattice cryptography-based application, the security strength that can be obtained by having a given modulus q for the underlying cryptographic protocol.

Definition 12 (Optimal(k− [symbol] )-incompleteness and q). For a given n and λ, the optimal (k− [symbol] )-incompleteness is defined as follows, as the pair of (cryptographically-relevant) [symbol] and q for which the gain function [symbol] ( [symbol] , q) is maximum:

$${max}_{ℓ , q} 𝒢 ( ℓ , q ) = 𝒲 ( Algorithm 4 ) - 𝒲 ( Algorithm 3 ) = S ( 2 \cdot {NTT}_{( ℓ , k )} + {invNTT}_{( ℓ , k )} ) - C ( BaseMul )$$

$$Satisfying 1 \leq ℓ < k ,$$

$$q ≡ 1 mod {2}^{ℓ + 1}$$

$$SecurityAchieved ( q ) \geq λ$$

### Optimal Incompleteness When q is Fixed

Definition 13 (Optimal (k- [symbol] )-incompleteness). For a given n and q, the optimal (k− [symbol] )-incompleteness is defined as follows, as the value of [symbol] for which the gain function [symbol] ( [symbol] ) is maximum.

$${max}_{ℓ} 𝒢 ( ℓ ) = 𝒲 ( Algorithm 4 ) - 𝒲 ( Algorithm 3 )$$

$$Satisfying 1 \leq ℓ < k$$

### Analysis

Since modular addition and multiplication consume varying numbers of CPU cycles and memory across different computing platforms, it is imperative to consider the actual arithmetic operation costs as part of the optimization process. Thus, it is useful to write the proposed optimization algorithms as functions of the costs of (modular) additions and multiplications measured in the target platform.

Definition 14. For a given finite field, let the cost associated with (modular) addition and multiplication in a given platform be α and μ, respectively.

Equation 2 becomes, then:

$$𝒲 ( Alg \text{.3} ) = 𝒲 ( {NTT}_{( ℓ , k )} ( a ) ) + 𝒲 ( {NTT}_{( ℓ , k )} ( b ) ) + {2}^{ℓ} \cdot 𝒲 ( {BaseMul}_{{2}^{k - {f}_{\times {2}^{k - ℓ}}} , {𝕫}_{q}} ) + 𝒲 ( {invNTT}_{( ℓ , k )} ( \hat{c} ) ) = 3 ℓ \cdot {2}^{k - 1} ( 2 a + μ ) + ( {2}^{2 k - ℓ} + {2}^{k} ) ( a + μ )$$

$$Similarly , Equation 1 becomes :$$

$$𝒲 ( Alg \text{.4} ) = 𝒲 ( {NTT}_{( k , k )} ( a ) ) + 𝒲 ( {NTT}_{( k , k )} ( b ) ) + {2}^{k} \cdot 𝒲 ( {PointWiseMul}_{1 \times 1 , {𝕫}_{q}} ) + 𝒲 ( {invNTT}_{( k , k )} ( \hat{c} ) ) = 3 \cdot k \cdot {2}^{k - 1} ( 2 a + μ ) + {2}^{k} \cdot μ$$

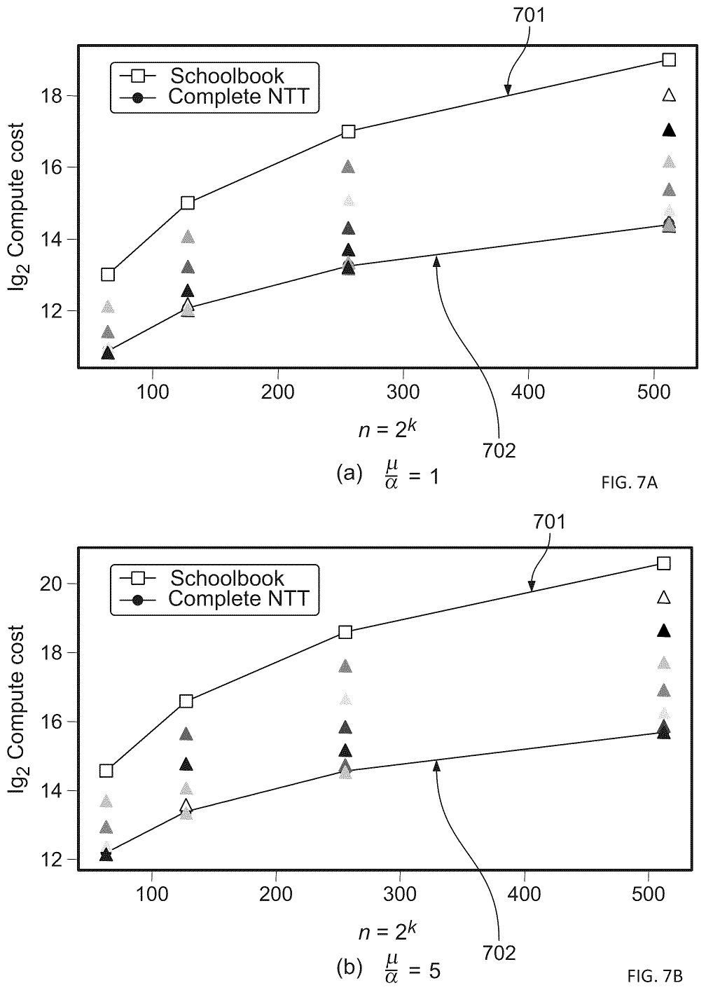

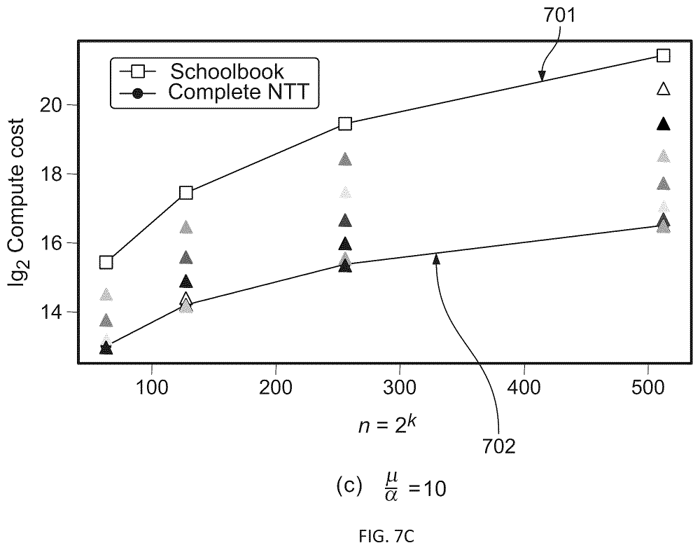

FIGS. 7A-7C depict the optimization problem with different values of the ratio of μ and α, with varying number of coefficients, e.g., n=[64,512]. The Y-axis shows the lg₂ values of the compute cost. The upper and lower lines, 701, 702, respectively, correspond to the compute cost associated with the Schoolbook and complete NTT algorithms.

For a given n, the all-possible incomplete NTT members of the family are marked by triangle-shaped markers. FIGS. 7A-7C show that at least a few triangle-shaped markers (associated with incomplete NTT options) are below the orange line of the complete NTT for each case, which states that for a reasonable value of

$$\frac{μ}{α} ,$$

there are a few options to choose from the incompleteness pool that perform better than the complete NTT.

All other points, i.e., values of varying incompleteness, are in-between the upper and lower lines, eventually better than Schoolbook.

Then, following Definition 8:

Observation 5. For a given n, the [symbol] ( [symbol] ) is the difference between

$$𝒲 ( {NTT}_{( ℓ , k )} ) and 𝒲 ( {NTT}_{( k , k )} ) , i . e . ,$$

$$𝒮 ( {NTT}_{( ℓ , k )} ) = 𝒲 ( {NTT}_{( k , k )} ) - 𝒲 ( {NTT}_{( ℓ , k )} ) = {2}^{k - 1} ( k - ℓ ) ( 2 a + μ ) .$$

$$Likewise ,$$

$$𝒮 ( {NTT}_{( ℓ , k )} ) = 𝒲 ( {NTT}_{( k , k )} ) - 𝒲 ( {NTT}_{( ℓ , k )} ) = {2}^{k - 1} ( k - ℓ ) ( 2 a + μ )$$

Then, following Definition 9:

Observation 6. For a given n, the [symbol] (BaseMul) is the difference between

$$𝒲 ( {BaseMul}_{{2}^{k - {f}_{\times {2}^{k - ℓ}}} , {𝕫}_{q}} ) and 𝒲 ( {PointWiseMul}_{1 \times 1 , {𝕫}_{q}} ) , i . e . ,$$

$$𝒞 ( BaseMul ) = {2}^{ℓ} \cdot 𝒲 ( {BaseMul}_{{2}^{k - {f}_{\times {2}^{k - ℓ}}} , {𝕫}_{q}} ) - {2}^{k} \cdot 𝒲 ( {PointWiseMul}_{1 \times 1 , {𝕫}_{q}} ) = {2}^{2 k - ℓ} ( α + μ ) + {2}^{k} \cdot ( α - μ )$$

Finally, given the values of n and λ from the underlying application, the platform-specific modular arithmetic costs of α and μ, as well as the set of constraints applicable to [symbol] and q, we solve the novel optimization problem below to maximize function [symbol] ( [symbol] , q) (see Definition 10 and Equations 8, 9):

$${max}_{ℓ , q} 𝒢 ( ℓ , q ) = 3 \cdot {2}^{k - 1} ( k - ℓ ) ( 2 α + μ ) - {2}^{2 k - ℓ} ( α + μ ) - {2}^{k} \cdot ( α - μ )$$

$$Satisfying :$$

$$1 \leq ℓ < k$$

$$q ≡ 1 mod {2}^{ℓ + 1}$$

$$SecurityAchieved ( q ) \geq λ$$

### Optimal if Input Polynomials in NTT Domain

For some cryptographic schemes, input polynomials in the NTT domain may be directly sampled, which saves the cost associated with executing NTT-related operations. If one of the given polynomials is already in the NTT domain, the Definition 10 yields:

Corollary 6. For a given n, when one polynomial is already in NTT domain, incompleteness is better if:

$$( NT {T}_{( ℓ , k )} + i n v N T {T}_{( ℓ , k )} ) > ( BaseMul ) .$$

The gain function in the optimization Equation 10 changes to:

$$𝒢 ( ℓ ) = 2 \cdot {2}^{k - 1} \cdot ( k - ℓ ) ( 2 α + μ ) - {2}^{2 k - ℓ} \cdot ( α + μ ) - {2}^{k} \cdot ( α - μ )$$

Similarly, if both input polynomials are already in the NTT domain, Definition 10 turns to:

Corollary 7. For a given n and q, when both polynomials are in NTT domain, incompleteness is better if

[symbol]

( [symbol] )> [symbol] (BaseMul).

The gain function in the optimization Equation 10 narrows down more to:

$$𝒢 ( ℓ ) = {2}^{k - 1} \cdot ( k - ℓ ) ( 2 α + μ ) - {2}^{2 k - ℓ} \cdot ( α + μ ) - {2}^{k} \cdot ( α - μ )$$

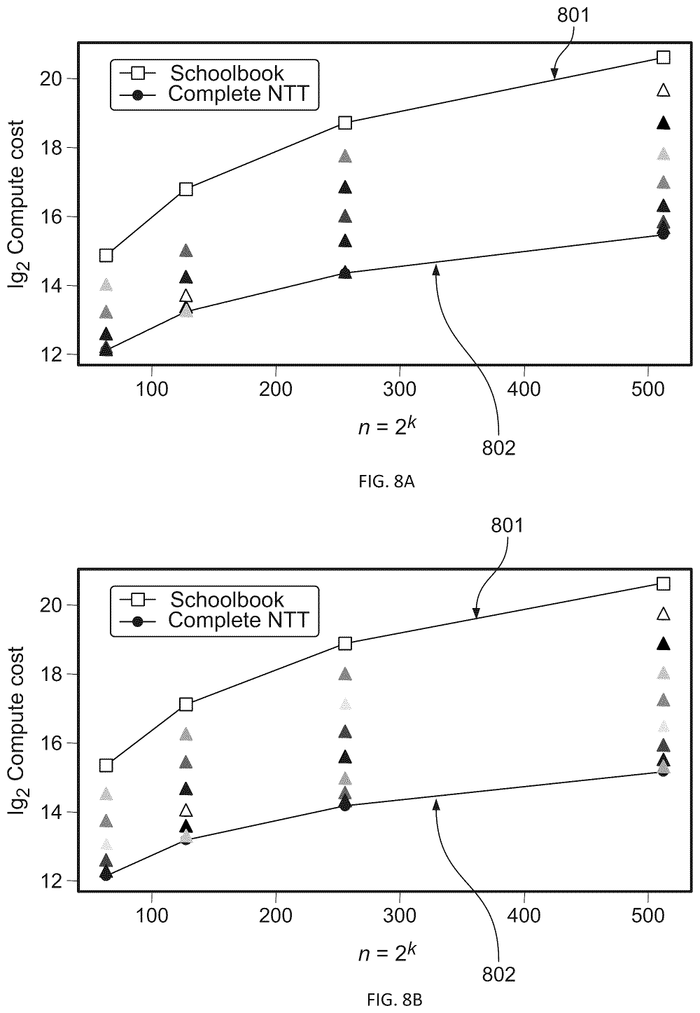

FIGS. 8A and 8B depict this observation with fixing

$$\frac{μ}{α} = 5.$$

Likewise, FIGS. 7A-7C, we have various n=[64,512] along the X-axis and the lg₂ values of the theoretical compute cost of Schoolbook, complete NTT, and all-possible incomplete NTT members for a given n along Y-axis.

We find that a few triangle-shaped markers (incomplete NTT options) that were better than complete NTT (in FIGS. 7A-7C) are either already (FIG. 8B) or about to (FIG. 8C) moving back inside the band created by the upper and lower lines, 801, 802, respectively.

Especially, when both input polynomials can be sampled directly at the NTT domain, the saving margin disappears (as also realized in the above corollaries), and complete NTT becomes the better choice. However, they are still comparable to the complete NTT performance, and since they (empowered by incompleteness) can enable a relaxed set of moduli, depending on the context, they can be a better choice, opening new tradeoffs.

### Benchmarking Optimal Incompleteness

Referring to the C testbed, discussed above, the performance of traditional polynomial multiplication strategies may be observed in comparison to the Schoolbook or Karatsuba algorithm for smaller-degree polynomials in the incomplete NTT setting according to the present disclosure.

As an example, an embodiment of the present disclosure may be evaluated for n={256, 512, 1024}, considering the scenarios where q is fixed as well as where q can be changed.

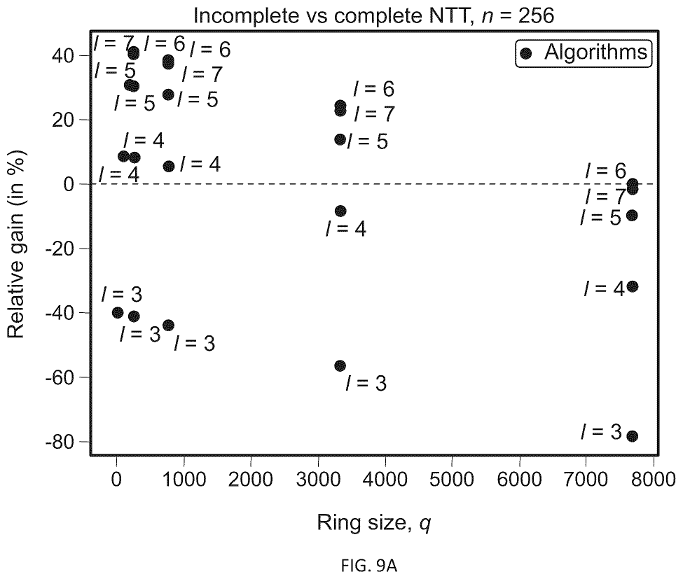

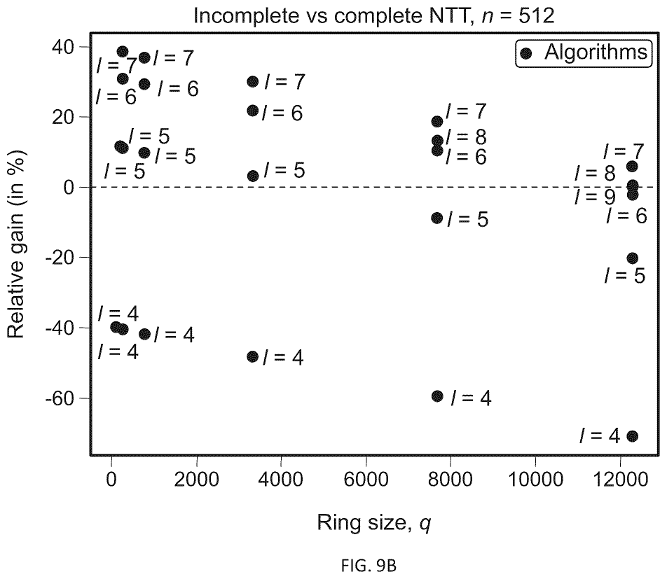

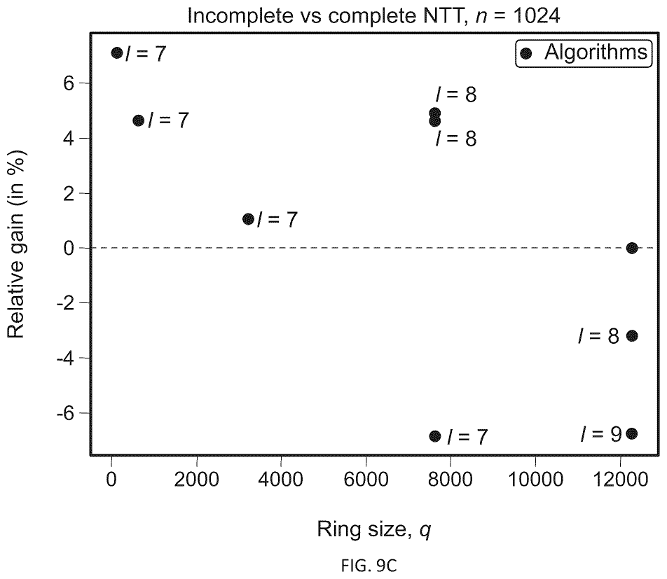

The experimental results are illustrated in FIGS. 9A-9C. The FIGS. 9A-9C show optimal [symbol] and q when two arbitrary polynomials are multiplied with a given n. Along the X-axis, we plot the gain as a percentage of incomplete NTT's cost relative to its complete counterpart, as defined below:

Definition 15 (Relative gain). Let [symbol] ᵣₑₗₐₜᵢᵥₑ be the relative gain of incomplete NTT-based PolyMul against complete NTT-based PolyMul. It is evaluated as

$${𝒢}_{relative} = \frac{𝒲 ( {NTT}_{( k , k )} ) - 𝒲 ( {NTT}_{( ℓ , k )} )}{𝒲 ( {NTT}_{( k , k )} )} = 1 - \frac{𝒲 ( {NTT}_{( ℓ , k )} )}{𝒲 ( {NTT}_{( k , k )} )}$$

In FIGS. 9A-9C, the performance of the regular complete NTT is indicated by a dotted line. Any points above this line are, thus, better than the complete NTT. As shown in the figures, for each n, there are many advantageous options available for the choice of [symbol] and q.

For instance, when n=256, q=3329, the (6,8)-layer incomplete NTT is better than any other possibilities, including the (8,8)-layer complete NTT.

When n=512 and the value of q is fixed to 12289, the (7,9)-layer incomplete NTT is better than (9,9)-layer complete NTT.

Furthermore, when q can be chosen, a (6,8)-layer incomplete NTT with q=257 is 41% faster than (8,8)-layer complete NTT, which needs q≥7681.

Similarly, by using smaller moduli for n={512,1024}, the incomplete NTT outperforms its complete counterpart with a considerable margin. Thus, a number of members of the incomplete NTT family are better than the complete NTT counterpart. However, as incompleteness permits smaller moduli, a significant performance enhancement can be acquired if the target application allows changed (smaller) moduli.

### Case Study: KEM Crystals-Kyber

In its original design, Kyber employed q=7681 as the underlying prime modulus and used a complete (8,8)-layer NTT for polynomial multiplication. The most recent version of Kyber, however, achieved faster polynomial multiplication by adopting 1-incompleteness in NTT and changing the modulus to q=3329, which is a particular case in the family of incomplete NTTs discussed herein.

In both versions, though, the set of parameters employed is such that: (1) the underlying MLWE problem is capable of effectively protecting the scheme's private key and ciphertext; and (2) the resulting decryption failure rate (DFR) is negligible—namely, 2⁻¹²⁸ for security level 1, and 2⁻¹⁶⁰ for security levels 2 and 3.

In embodiments of the present disclosure, Kyber's choice of parameters is evaluated, as well as alternatives, by seeking the optimal value of incompleteness under varying practical constraints. For comparison purposes, the current Kyber configuration is indicated as the default setup.

For the experiments presented in this discussion, we use the reference implementation in the C programming language of Kyber, namely the constant-time one provided by PQClean. As a target hardware, ARM Cortex-M4 is selected due to its wide availability in commercial applications. In particular, the experiments were performed on the STM32 Nucleo-F439ZI development board. The cycle count measurements were collected from the Cortex-M4's Data Watchpoint and Trace (DWT) registers. The board's clock prescaler factors were also configured to achieve the frequency of 28 MHz. At this frequency, there is only one CPU cycle of latency to fetch the instructions from the flash memory. This minimizes the effect of the memory controller's wait states when performing the cycle count benchmarks.

On the software side, the arm-none-eabi-gcc version 9.2.1 compiler was utilized for bare-metal Cortex-M targets with the flags -O3-mcpu=cortex-m4-mfpu=fpv4-sp-d16-mfloat-abi=hard-mthumb.

The middleware code for the configuration of the board's peripherals (e.g., UART, timers, and TRNG) was generated using the STM32 CubeMX tool. For each experiment, the average execution time was evaluated for a series of 100 runs, which led to a negligible standard deviation (below 0.003% for most of the cases and 0.30% for the keypair generation). The correctness of each modification done in the PQClean reference implementation was checked, ensuring that all KEM procedures could be properly executed—keypair generation, encapsulation, and decapsulation.

### Optimizing Performance and Modulus

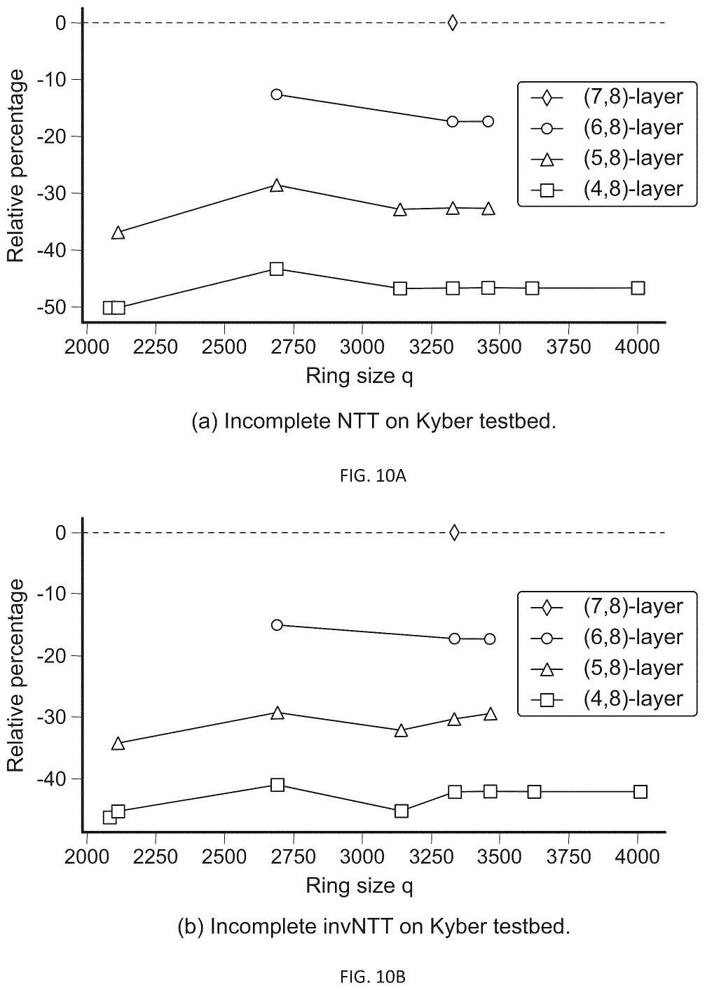

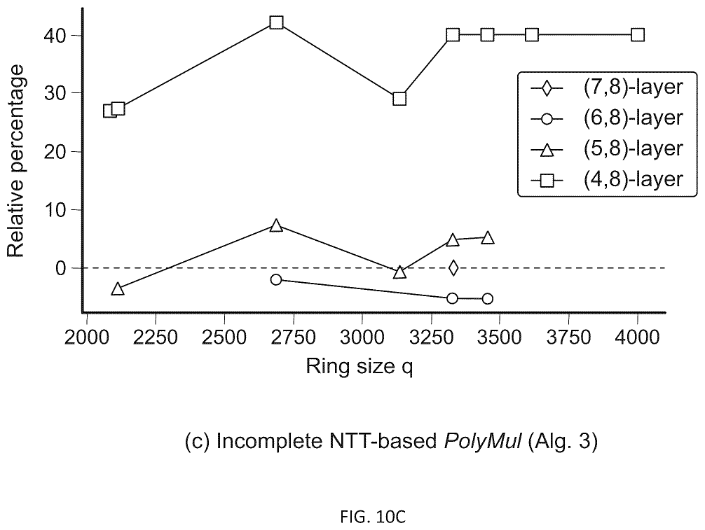

Initially, the performance of the following operations in Kyber are discussed: incomplete NTT (FIG. 10A); incomplete invNTT (FIG. 10B); and full polynomial multiplication (FIG. 10C). As expected, more incompleteness leads to NTT and invNTT procedures requiring less computation.

For instance, a call to the (4,8)-layer incomplete NTT function is faster than any ( [symbol] >4,8)-layer options. However, higher incompleteness incurs overhead in the base multiplication (exhibited in Table 1 below, i.e., it requires the multiplication of higher-degree constituent polynomials as discussed in Algorithm 3.

TABLE 1
(Cycles consumed to execute BaseMul for (7,8)-
layer to (4,8)-layer incomplete NTT-based polynomial
multiplication options, Algorithm 3):

| BaseMul | #cycles |
|---|---|
| [symbol] | 134 |
| [symbol] | 450 |
| [symbol] | 1766 |
| [symbol] | 7112 |

Consequently, the overall polynomial multiplication performance exhibits different results. More precisely, as discussed above, for example in Definition 10, better performance is observed if two calls to incomplete NTT and one call to incomplete invNTT save more cycles than the overhead added to the comparatively higher-degree polynomial-based base multiplication.

In particular, as shown in FIG. 10C, a (6,8)-layer incomplete NTT-based polynomial multiplication is 5% faster than the one observed in the current Kyber specification, i.e., (7,8)-layer member.

As discussed above, NTT incompleteness also allows a more relaxed set of moduli. For example, for a given range, say 2048<q<4096 (i.e., the prime moduli that need 12 bits to represent), (5,8)-layer incomplete NTT supports more moduli. (e.g., 2113, 2689, 2753, 3137, 3329, 3457) than that of (6,8)-layer incomplete NTT (with only 2689, 3329, 3457). Whereas, the default (7,8)-layer permits only one prime modulus (3329) in this range, being restrictive. Therefore, for each level of incompleteness, performance is measured under different q from the union set {2081, 2113, 2689, 3137, 3329, 3457, 3617, 4001} obtaining the results shown in FIGS. 10A-10C.

Based on the results, it is shown that a given level of incompleteness leads to similar performance for the multiplication between two arbitrary polynomials, except for a few moduli (e.g., 2689 and 3457). Isolating the compiler-generated assembly code for the (6,8)-layer incomplete NTT with q=2689 and q=3457, both assembly snippets looked identical except for the zeta table (twiddle factor) values.

In addition, instruction counters were inserted to check how many times each assembly label block was being accessed in both cases. Since the observed counter values were the same for both cases, it is shown that the instruction execution counts are also equal for both q=2689 and q=3457 cases. Hence, this difference is not being caused by divergences in the compiler outputs. Instead, it is happening during the code execution.

Overall, the (4,8)-and (5,8)-layers are respectively 40% and 5% slower than the default (7,8)-layer incomplete NTT chosen by Kyber. However, (6,8)-layer incomplete NTT-based polynomial multiplication is 5% faster than the (7,8)-layers. Therefore, for polynomial multiplication, the (6,8)-layer with either q=3329 or 3457 would be a better choice.

However, since Kyber allows sampling one or both of the input polynomial(s) directly in the NTT domain, those gains in the standalone polynomial multiplication are not reflected in Kyber's keypair generation, encapsulation, and decapsulation operations.

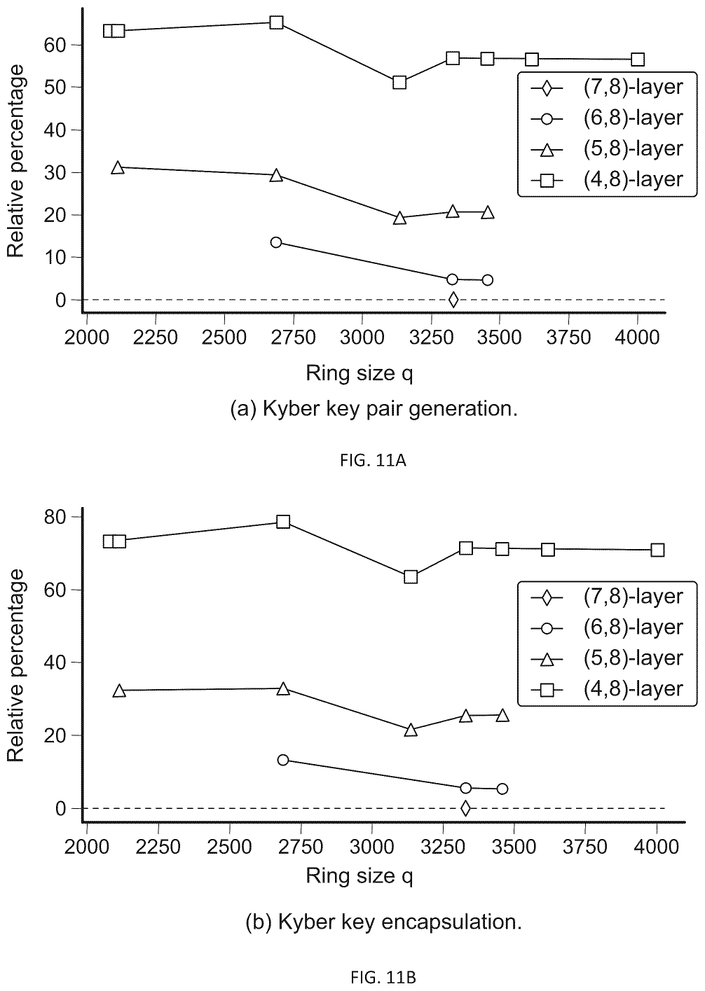

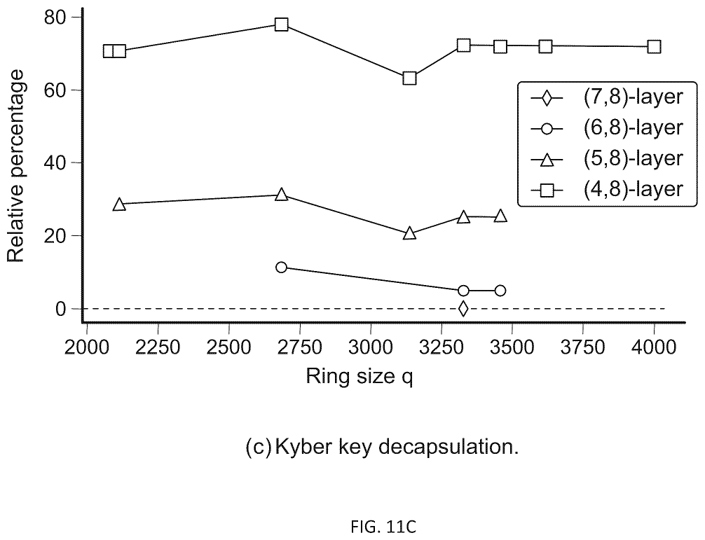

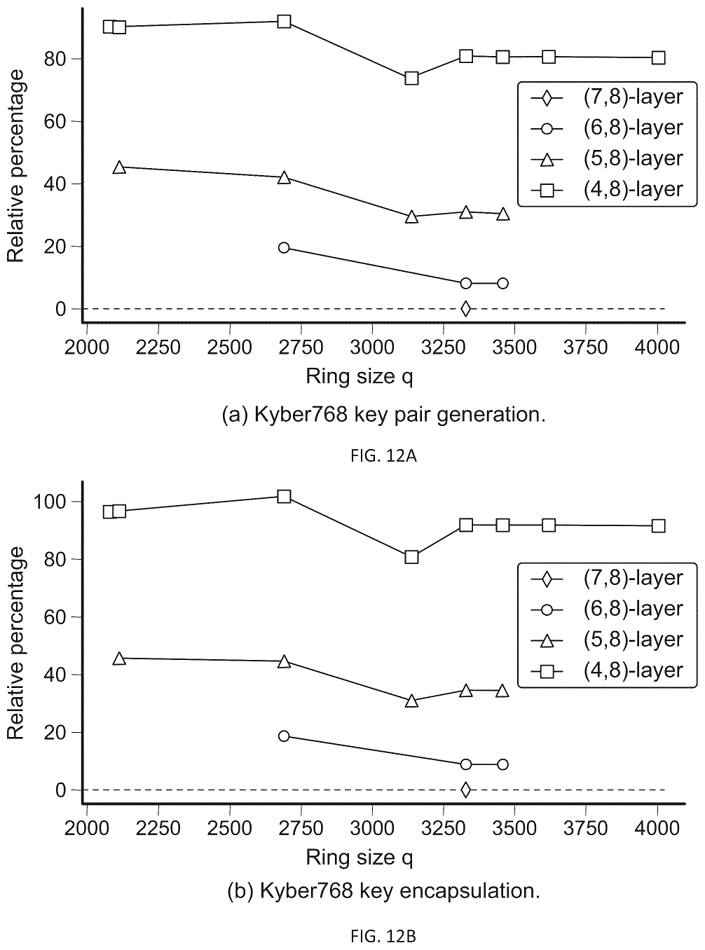

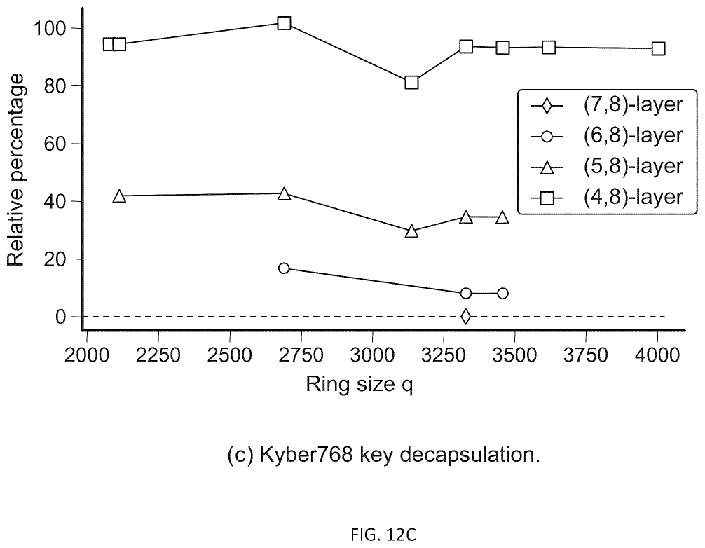

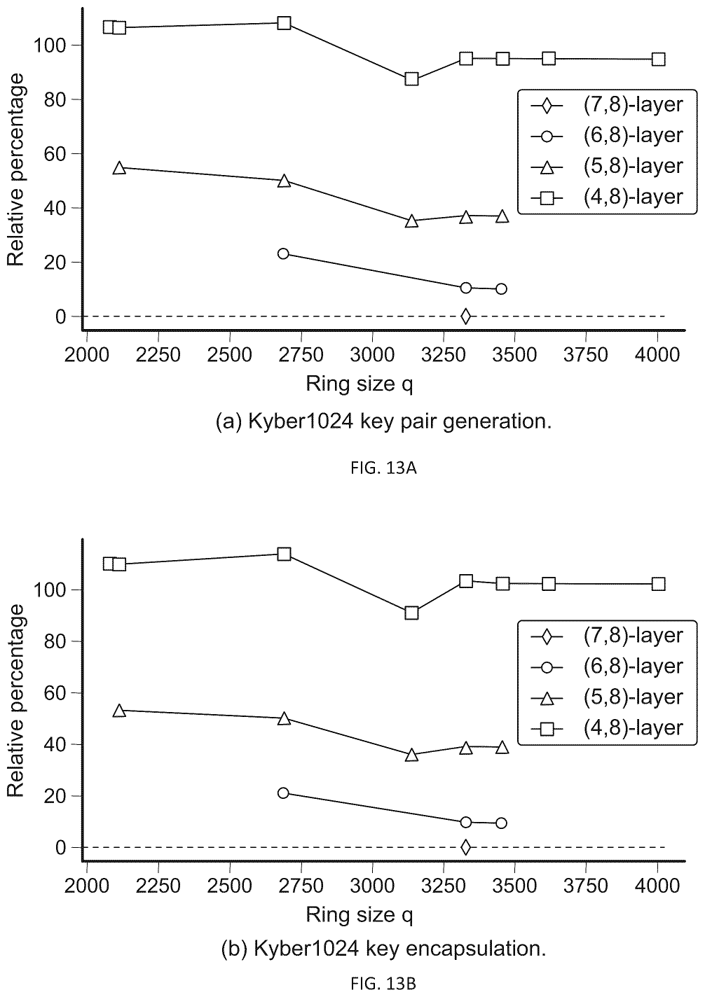

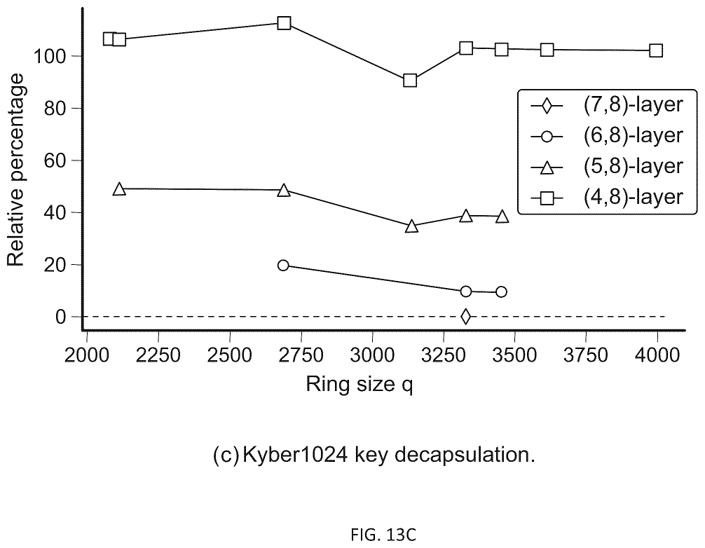

More precisely, saving at most one call to NTT and one call to invNTT often could not supersede the overhead in schoolbook-based base multiplication. This difference accumulated over all polynomial multiplications involved in Kyber's operations, resulting in a performance hit of 5%, 8%, and 10% for (6,8)-layer incomplete NTT-based Kyber512 (FIGS. 11A-11C), Kyber768 (FIGS. 12A-12C), and Kyber1024 (FIGS. 13A-13C).

FIGS. 12A-12C depict the cycles spent to execute modified PQClean reference implementation of Kyber 768 on an ARM Cortex-M4 device to enable incompleteness in NTT/invNTT and associated and selected moduli. Along the y-axis is the relative percentage of each case compared to the default case, i.e., (7,8)-layer NTT with q=3329 marked by a diamond-shaped point with a 0% relative cycle.

FIGS. 13A-13C depict the cycles spent to execute modified PQClean reference implementation of Kyber1024 on an ARM Cortex-M4 device to enable various incompleteness in NTT/invNTT and associated and selected moduli. Along the y-axis is the relative percentage of each case compared to the default case, i.e., (7,8)-layer NTT with q=3329, marked by a diamond-shaped point with a 0% relative cycle.

### Optimizing DFR and Ciphertext Size

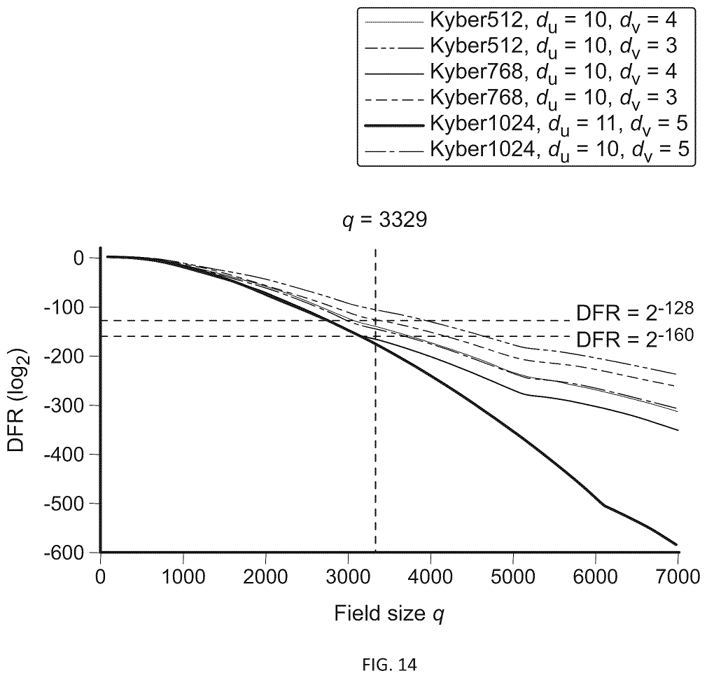

The impact and new tradeoffs between several factors leveraging the incompleteness will be discussed. FIG. 14 illustrates how the value of (dᵤ, dᵥ) pair affects the DFR when the modulus q (in the X-axis) is changed.

The parameter pair (dᵤ, dᵥ) represents the number of bits into which the coefficients from the two parts of the ciphertext are compressed. More specifically, FIG. 14 depicts DFRs for Kyber with all three security levels for varying moduli leveraged by incompleteness in NTT with current and proposed values of (dᵤ, dᵥ) depicted by solid and dashed lines, respectively. A vertical dashed line illustrates the default modulus 3329, and two horizontal lines show target DFR values for security level 1 and security levels 3 and 5.

It is shown that for any case—current values (solid lines) as well as new values (dashed lines) of the pair by either decreasing dᵤ or dᵥ—when q is increased, the DFR also decreases. Note that for a key encapsulation mechanism (KEM) to ensure security against chosen-ciphertext attacks (CCAs), it must be resistant to attacks that exploit decryption failures. Therefore, for some applications, lower DFR values are required, and increasing modulus—enabled by getting a relaxed set of modulus options through incompleteness—can be beneficial.

For example, when the value of dᵥ or dᵤ is decreased by 1 for a given q, the DFR gets higher, following the dashed lines for all security levels of Kyber. From the definition, lower dᵤ or dᵥ facilitates shorter ciphertext sizes. This flexibility on the value of q, enabled by our family of incomplete NTTs, is useful when one desires to achieve a particular DFR for a specific application context.

For instance, this feature may be beneficial for a compressed ciphertext size. The value dᵤ or dᵥ may be lowered. However, as discussed, lowering dᵤ or dᵥ increases the DFR. Conversely, the modulus may be increased from 3329 to compensate for that change in DFR and still support the minimum value of it.

### Proposed Parameter Sets With New Tradeoffs

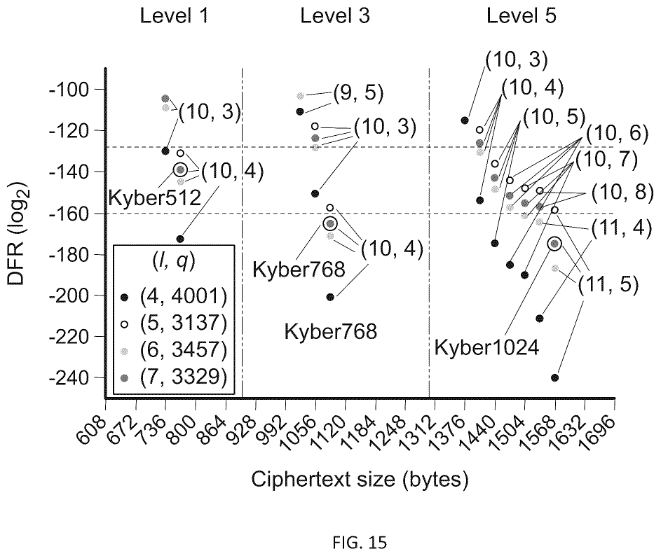

FIG. 15 shows that the proposed family of incomplete NTT members contributes new options for the balance between DFR and ciphertext compression for all security levels. Specifically, FIG. 15 depicts new tradeoffs concerning DFRs, ciphertext compressions for Kyber via NTT incompleteness.

The plot shown in FIG. 15 shows DFR and cyphertext sizes for pairs of compression parameters (dᵤ, dᵥ) when using different moduli. ( [symbol] , q) pairs are illustrated in solid circles and (dᵤ, dᵥ) pairs are annotated in groups by arrows. The current Kyber setups for all security levels are marked by second circles. Three vertical dashed lines separate three regions, and two horizontal dashed lines showcase the target DFR values of three security levels.

Embodiments of the present disclosure enable a broader and relaxed set of prime moduli q={4001, 3137, 3457} by introducing more incompleteness [symbol] ={4, 5, 6}, respectively than the default selection with q=3329 and [symbol] =7. The corresponding new points are marked in corresponding dots, respectively, and the current point is marked in black. For each security level, there are several new points that fall under the target DFR value (i.e., 2⁻¹²⁸ for level 1 and 2⁻¹⁶⁰ for levels 3 and 5).

For instance, Kyber512 (security level 1) has four points that either acquire better ciphertext compression or lower DFR than that of the current choice. Likewise, Kyber768 (security level 3) has two, and Kyber1024 (security level 5) has eight new parameter sets. Out of these new choices, some can achieve extremely low DFR (e.g., 2⁻²⁴⁰) or shorter ciphertext (e.g., 8% compression). According to the embodiments of the present disclosure and the details of each application, a PQC practitioner can choose one of them.

In the particular case of Kyber1024, an interesting trade-off is available with parameters (dᵤ=10, dᵥ=7, q=3457, [symbol] =6): the result is a DFR that remains below the target of 2⁻¹⁶⁰, while delivering 4% more compressed ciphertexts than the standardized choice. In terms of performance, this choice of q=3457 in Kyber1024 leads to an overhead of approximately 9% for keypair generation, encapsulation, and decapsulation (see FIG. 13A-13C).

In view of the above, embodiments of the present disclosure include configurations in which a polynomial multiplication related operation—such as a cryptographic operation, for example—may be optimized based not only on algorithmic factors such as a number of coefficients n and a target security strength, but also based on the specific configuration of a particular device implementing the application. Whereas existing techniques, such as incomplete Kyber—discussed above—merely present a general approach for performing incomplete layers of NTT and invNTT for slight performance gain, such prior art approaches fail to incorporate the correlation between various potential alternatives and performance, ciphertext size, and other specific metrics of each particular implementation.

Referring back to FIG. 6, a resource-constrained device 600—also referred to as an electronic device, edge device, target computing platform, or the like—may be selected for performing an operation involving polynomial multiplication related operations, for example a cryptographic operation such as generating a private key, generating a digital signature, verifying a digital signature, encrypting data, or decrypting data. In FIG. 6, such operation is shown by way of example by a fully homomorphic encryption (FHE) application 601 or a post-quantum cryptography (PQC) application 602.

Embodiments of the present disclosure may allow a computing terminal, such as a computer, also referred to as a configuration terminal or configuration computing platform, used for configuring, designing, manufacturing, or implementing a deployed device, also referred to as a resource-constrained device, to optimize execution of the FHE or PQC application by the resource-constrained device based on particular parameters given for the platform specific implementation of the FHE or PQC application, in view of the hardware, software, or algorithmic capabilities of the resource-constrained device. This provides clear benefit over existing approaches, such as incomplete Kyber for example, which merely focus on general improvements in performance of executing polynomial multiplication algorithms, without consideration for platform specific constraints or operation implementation requirements.

By way of some non-limiting examples, the resource-constrained device may one of a number of device types, such as a mobile device, mobile phone, laptop computer, tablet computer, smart watch, health monitoring device, home security device, home camera, motion sensor, personal identification device, smart home device, smart appliance, or any other types of devices which would benefit in performance or efficiency from an optimized configuration for performing a polynomial multiplication related operation, such as a cryptographic operation.

According to embodiments of the present disclosure, based on the hardware, software, and algorithm configuration of the resource-constrained device 600, values representing the computational cost of performing modular addition (α) 600a by the resource-constrained device and the computational cost of performing modular multiplication (μ) 600b by the resource-constrained device may be obtained.

Additionally, polynomial multiplication related operation, such as FHE 601 or PQC 602 may have predetermined values for a number of coefficients n of the input polynomials and a corresponding minimum required security strength λ, shown at 601a and 602a, respectively, based on requirements specific to each application. In some embodiments of the present disclosure, the polynomial multiplication related operation may be non-cryptographic in nature, and the operation may be implemented in specific applications including signal processing, video and image processing, communication protocols, or the like. In such cases, the specific applications may place constraints on the polynomial multiplication parameters, including the number of coefficients n of the input polynomials and particular application setting(s), akin to the minimum required security strength λ in the cryptographic applications, which may be similarly applied.

In the examples of FHE 601 or PQC 602 shown in FIG. 6, once parameter values for the number of coefficients n of the input polynomials, the minimum required security strength λ 601a/602a, and the cost of modular addition 600a and the cost of modular multiplication 600b of the resource constrained device, the configuration terminal may optimize the polynomial multiplication related operation for execution by the resource constrained device by generating optimized values [symbol] and q 604, representing the optimal level of incompleteness of NTT to be used in the polynomial multiplication, and the optimal prime modulus.

The configuration terminal may provide the generated values [symbol] and q 604 to the resource-constrained device 600 for performing the FHE 601 or PQC 602 applications, or otherwise cause the resource-constrained device to perform the applications using the generated optimized values 604. It will be understood by those of ordinary skill in the art that the generated optimized values may be configured, transmitted, designed, stored, or otherwise provided by the configuration terminal directly or indirectly to the resource-constrained device 600 for execution of the FHE 601 or PQC 602 applications using the generated optimized values 604. Once configured with the generated optimized values 604, the resource-constrained device 600 may execute the FHE 601 or PQC 602 application based on the generated optimized values 604 according to the minimum security strength or other minimum requirements 601a while achieving optimal performance within allowable DFR tradeoff.

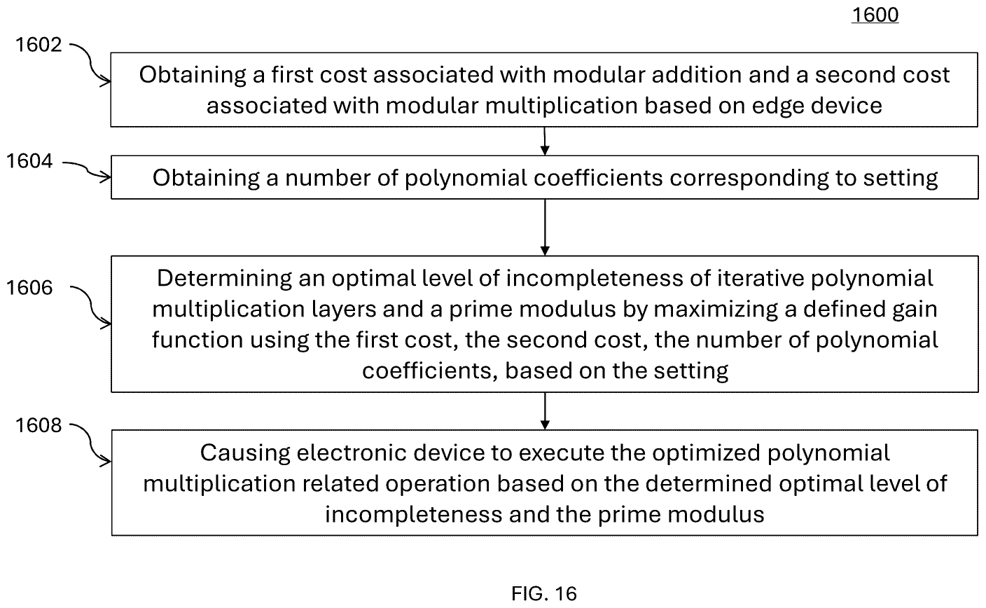

Based on the above discussion, FIG. 16 depicts a method 1600 of optimizing an iterative polynomial multiplication related operation for execution by a target computing platform according to an embodiment of the present disclosure. The target computing platform may be a resource constrained device, such as a deployed edge device.

In an embodiment of the present disclosure, the method 1600 includes obtaining, at 1602, a first cost associated with modular addition and a second cost associated with modular multiplication based on a configuration of the target computing platform. The first cost and the second cost may be based on a particular algorithmic, hardware, and/or software configuration and implementation of a target computing platform, for performing polynomial multiplication related operations, including quantum-safe key encapsulation, digital signature algorithms, or homomorphic encryption.

The method further includes, at 1604, obtaining a number of polynomial coefficients and corresponding dimension of the polynomial coefficients for the iterative polynomial multiplication related operation corresponding to a particular setting of the iterative polynomial multiplication related operation. In some embodiments wherein the modulus q can be configured, the particular setting may correspond to a desired security strength for an underlying cryptographic protocol. In some embodiments, q may be fixed, which may correspond to the security strength being set accordingly and the particular setting may not be parameterized.

Further, the method may include, at 1606, determining an optimal level of incompleteness of iterative polynomial multiplication layers of the iterative polynomial multiplication related operation and a prime modulus—where the modulus can be configured—by maximizing a defined gain function using the first cost, the second cost, the number of polynomial coefficients, and the dimension of the polynomial coefficients, based on the particular setting. In some embodiments, maximizing the defined gain function may correspond to determining, for a given n and λ, the combination of [symbol] and q resulting in a largest savings of computational work of ( [symbol] , k)-incomplete NTT vs (k, k)-complete NTT.

In some embodiments the determination of the optimal level of incompleteness and the prime modulus includes determining the level of incompleteness and the prime modulus resulting in a largest difference between a first computational cost of a complete execution of the iterative polynomial multiplication layers of the iterative polynomial multiplication related operation and each of a plurality of second computational costs respectively associated with varying levels of incompleteness of execution of the iterative polynomial multiplication layers of the iterative polynomial multiplication related operation.

After determining the combination of [symbol] and q, the method includes, at 1608, causing the target computing platform, for example a deployed edge device, to execute the optimized polynomial multiplication related operation based on the determined optimal level of incompleteness and the prime modulus, the combination of [symbol] and q, respectively.

According to embodiments of the present disclosure, optimized ( [symbol] , k)-layer incomplete NTTs demonstrate better performance than complete NTT for polynomial multiplication in a quotient ring, a core component of lattice-based cryptography. This enables more efficient implementations of many post-quantum cryptography (PQC) and fully homomorphic encryption (FHE) schemes.

The performance of the optimized incomplete NTTs according to the embodiments of the present disclosure achieve smaller ciphertext sizes and lower decryption failure rates (DFR) than the current standard. This study is general and adaptable, making it useful across different platforms and lattice-based cryptographic applications.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first”, “second”, etc. may be used herein to describe various elements, these elements should not be limited by these terms. These terms are only used to distinguish one element from another. For example, a first image could be termed a second image, and, similarly, a second image could be termed a first image, which changing the meaning of the description, so long as the occurrences of the “first image” are renamed consistently and the occurrences of the “second image” are renamed consistently. The first image and the second image are both images, but they are not the same image.

The terminology used herein is for the purpose of describing particular implementations only and is not intended to be limiting of the claims. As used in the description of the implementations and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The present disclosure is not limited to what has been described above, and other aspects and advantages of the present disclosure not mentioned above will be understood through the following description of embodiments of the present disclosure. Further, it will be understood that the aspects and advantages of the present disclosure may be achieved by the configurations described in claims and combinations thereof.

In accordance with some implementations, an electronic device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of an electronic device, cause the electronic device to perform or cause performance of any of the methods described herein. In accordance with some implementations, an electronic device includes: one or more processors, a non-transitory memory, and means for performing or causing performance of any of the methods described herein.

What is claimed is:

1. A method for optimizing an iterative polynomial multiplication related operation for execution by an electronic device, the method comprising:
obtaining a first cost associated with modular addition and a second cost associated with modular multiplication based on a configuration of the electronic device;
obtaining a number of polynomial coefficients for the iterative polynomial multiplication related operation corresponding to a particular setting of the iterative polynomial multiplication related operation;
determining an optimal level of incompleteness of iterative polynomial multiplication layers for performing the iterative polynomial multiplication related operation and an optimal prime modulus for performing the iterative polynomial multiplication related operation by maximizing a defined gain function using the first cost, the second cost, and the number of polynomial coefficients, based on the particular setting;
wherein maximizing the defined gain function comprises determining the optimal level of incompleteness and the prime modulus resulting in a largest difference between a first computational cost of a complete execution of the iterative polynomial multiplication layers of the iterative polynomial multiplication related operation and each of a plurality of second computational costs respectively associated with varying prime moduli and levels of incompleteness of execution of the iterative polynomial multiplication layers of the iterative polynomial multiplication related operation; and
causing the electronic device to execute the optimized polynomial multiplication related operation based on the determined optimal level of incompleteness and the prime modulus.

2. The method of claim 1, wherein the optimized iterative polynomial multiplication related operation is executed by performing a first number of layers of polynomial multiplication of the optimized iterative polynomial multiplication related operation using a first polynomial multiplication algorithm, and performing remaining tasks of polynomial multiplication of the optimized polynomial multiplication related operation using a second polynomial multiplication algorithm,
wherein the first number is determined as the optimal level of incompleteness.

3. The method of claim 2, wherein the first polynomial multiplication algorithm utilizes Number Theoretic Transform (NTT)-based polynomial multiplication.

4. The method of claim 3, wherein the second polynomial multiplication algorithm is a Karatsuba or Schoolbook polynomial multiplication algorithm.

5. The method of claim 1, wherein the prime modulus is fixed for determining the optimal level of incompleteness.

6. The method of claim 1, wherein the iterative polynomial multiplication related operation is a cryptographic operation and the particular setting is a target security level of the cryptographic operation.

7. The method of claim 6, further comprising:
determining a set of prime modulus candidates satisfying the target security level for each level of incompleteness of polynomial multiplication layers of the iterative polynomial multiplication related operation,
wherein the prime modulus is included in one set of prime modulus candidates.

8. The method of claim 7, wherein each prime modulus in a set of prime modulus candidates is equivalent to 1 mod [symbol] , where [symbol] represents a respective level of incompleteness of polynomial multiplication layers of the cryptographic operation corresponding to the set.

9. The method of claim 1, further comprising:
determining a set of prime modulus candidates satisfying the particular setting for each level of incompleteness of polynomial multiplication layers of the iterative polynomial multiplication related operation,
wherein the prime modulus is included in one set of prime modulus candidates.

10. The method of claim 9, wherein each prime modulus in a set of prime modulus candidates is equivalent to 1 mod [symbol] , where [symbol] represents the optimal level of incompleteness of polynomial multiplication layers of the polynomial multiplication related operation.

11. The method of claim 1, wherein the iterative polynomial multiplication related operation is executed based on the determined optimal level of incompleteness and the prime modulus to perform at least one of:
generating a public key;
generating a private key;
generating a digital signature;
verifying a digital signature;
encrypting data; or
decrypting data.

12. A non-transitory computer-readable medium storing instructions that, when executed by a processor of a first electronic device, causes the first electronic device to:
obtain a first cost associated with modular addition and a second cost associated with modular multiplication based on a configuration of a second electronic device on which an optimized iterative polynomial multiplication related operation is to be performed;
obtaining a number of polynomial coefficients for the iterative polynomial multiplication related operation corresponding to a particular setting of the iterative polynomial multiplication related operation;
determining an optimal level of incompleteness of iterative polynomial multiplication layers for performing the iterative polynomial multiplication related operation and an optimal prime modulus for performing the iterative polynomial multiplication related operation by maximizing a defined gain function using the first cost, the second cost, and the number of polynomial coefficients, based on the particular setting;
wherein maximizing the defined gain function comprises determining the optimal level of incompleteness and the prime modulus resulting in a largest difference between a first computational cost of a complete execution of the iterative polynomial multiplication layers of the iterative polynomial multiplication related operation and each of a plurality of second computational costs respectively associated with varying prime moduli and levels of incompleteness of execution of the iterative polynomial multiplication layers of the iterative polynomial multiplication related operation; and
providing to the second electronic device configuration of the optimized polynomial multiplication related operation for execution by the second electronic device based on the determined optimal level of incompleteness and the prime modulus.

13. The non-transitory computer-readable medium of claim 12, wherein the optimized iterative polynomial multiplication related operation is executed by performing a first number of layers of polynomial multiplication of the optimized iterative polynomial multiplication related operation using a first polynomial multiplication algorithm, and performing remaining tasks of polynomial multiplication of the optimized polynomial multiplication related operation using a second polynomial multiplication algorithm,
wherein the first number is determined as the optimal level of incompleteness.

14. The non-transitory computer-readable medium of claim 13, wherein the first polynomial multiplication algorithm utilizes Number Theoretic Transform (NTT)-based polynomial multiplication, and
wherein the second polynomial multiplication algorithm is a Karatsuba or Schoolbook polynomial multiplication algorithm.

15. The non-transitory computer-readable medium of claim 12, wherein the prime modulus is fixed for determining the optimal level of incompleteness.

16. The non-transitory computer-readable medium of claim 12, wherein the iterative polynomial multiplication related operation is a cryptographic operation and the particular setting is a target security level of the cryptographic operation.

17. The non-transitory computer-readable medium of claim 16, wherein execution of the instructions further causes the first electronic device to:
determine a set of prime modulus candidates satisfying the target security level for each level of incompleteness of polynomial multiplication layers of the iterative polynomial multiplication related operation,
wherein the prime modulus is included in one set of prime modulus candidates.

18. The non-transitory computer-readable medium of claim 17, wherein each prime modulus in a set of prime modulus candidates is equivalent to 1 mod [symbol] , where [symbol] represents a respective level of incompleteness of polynomial multiplication layers of the cryptographic operation corresponding to the set.

19. The non-transitory computer-readable medium of claim 12, wherein execution of the instructions further causes the first electronic device to:
determine a set of prime modulus candidates satisfying the particular setting for each level of incompleteness of polynomial multiplication layers of the iterative polynomial multiplication related operation,
wherein the prime modulus is included in one set of prime modulus candidates.

20. The non-transitory computer-readable medium of claim 19, wherein each prime modulus in a set of prime modulus candidates is equivalent to 1 mod [symbol] , where [symbol] represents the optimal level of incompleteness of polynomial multiplication layers of the polynomial multiplication related operation.

21. The non-transitory computer-readable medium of claim 12, wherein the iterative polynomial multiplication related operation is executed based on the determined optimal level of incompleteness and the prime modulus to perform at least one of:
generating a public key;
generating a private key;
generating a digital signature;
verifying a digital signature;
encrypting data; or
decrypting data.

22. A system for optimizing an iterative polynomial multiplication related operation for execution by an electronic device, the system comprising:
one or more processors; and
a memory storing instructions that, when executed by the one or more processors causes the system to:
obtain a first cost associated with modular addition and a second cost associated with modular multiplication based on a configuration of an electronic device on which an optimized iterative polynomial multiplication related operation is to be performed;
obtain a number of polynomial coefficients for the iterative polynomial multiplication related operation corresponding to a particular setting of the iterative polynomial multiplication related operation;
determine an optimal level of incompleteness of iterative polynomial multiplication layers for performing the iterative polynomial multiplication related operation and an optimal prime modulus for performing the iterative polynomial multiplication related operation by maximizing a defined gain function using the first cost, the second cost, and the number of polynomial coefficients, based on the particular setting;
wherein maximizing the defined gain function comprises determining the optimal level of incompleteness and the prime modulus resulting in a largest difference between a first computational cost of a complete execution of the iterative polynomial multiplication layers of the iterative polynomial multiplication related operation and each of a plurality of second computational costs respectively associated with varying prime moduli and levels of incompleteness of execution of the iterative polynomial multiplication layers of the iterative polynomial multiplication related operation; and
provide to the electronic device configuration of the optimized polynomial multiplication related operation for execution by the electronic device based on the determined optimal level of incompleteness and the prime modulus.
